(19) United States
(12) Patent Application Publication
(10) Pub. No.: US 2010/0020210 A1
(43) Pub. Date: Jan. 28, 2010

(54) Image Sensing Device And Image Processing Device

(75) Inventors: Norikazu TSUNEKAWA, Hyogo (JP); Seiji OKADA, Osaka (JP); Akihiro MAENAKA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co. Ltd., Osaka (JP)

(21) Appl. No.: 12/509,206

(22) Filed: Jul. 24, 2009

(30) Foreign Application Priority Data
Jul. 24, 2008 (JP) 2008-190832

(51) Int. Cl. H04N 5/335

(52) U.S. Cl. 348/294; 348/E05.024

(57) ABSTRACT

There is provided an image sensing device including: an image acquisition portion that switches between a plurality of reading methods in which pixel signals of a group of light receiving pixels arranged in an image sensor are read and that thereby acquires, from the image sensor, a first image sequence formed such that a plurality of first images having a first resolution are arranged chronologically and a second image sequence formed such that a plurality of second images having a second resolution higher than the first resolution are arranged chronologically; and an output image sequence generation portion that generates, based on the first and second image sequences, an output image sequence formed such that a plurality of output images having the second resolution are arranged chronologically, in which a time interval between sequentially adjacent two output images among the plurality of output images is shorter than a time interval between sequentially adjacent two second images among the plurality of second images.

This nonprovisional application claims priority under 35 U.S.C. § 119(a) on Patent Application No. 2008-190832 filed in Japan on Jul. 24, 2008, the entire contents of which are hereby incorporated by reference.

### BACKGROUND OF THE INVENTION

1. Field of the Invention

The present invention relates to an image sensing device such as a digital video camera and an image processing device.

2. Description of Related Art

When moving images are shot by an image sensor that can shoot a still image composed of a plurality of pixels, it is necessary to reduce a frame rate according to the rate at which pixel signals are read from the image sensor. As, in order for a high frame rate to be achieved, the rate at which pixel signals are read from the image sensor is increased, power consumption is increased. For example, when an interline CCD is used as an image sensor, it is possible to achieve a high frame rate by driving a horizontal transfer path at a high speed. However, such high-speed drive causes charge transfer efficiency to be reduced, with the result that the power consumption and the amount of heat generated are increased.

In order to achieve a high frame rate without causing such increased power consumption, it is necessary to reduce the amount of image data either by reading pixel signals obtained as a result of pixel signals being added together or by reading pixel signals obtained as a result of given pixel signals being skipped. However, such addition reading or skip reading causes the amount of image data to be reduced, with the result that the resolution of the image shot is decreased. Needles to say, it is extremely important to develop technology with which moving images having a high frame rate and a high resolution are produced at low consumption power.

A technology is proposed in which, with a high-resolution low-frame-rate camera and a low-resolution high-frame-rate camera, a low-frame-rate high-resolution image sequence and a high-frame-rate low-resolution image sequence are read simultaneously from the respective cameras, and in which, based on those image sequences, a high-frame-rate high-resolution output image sequence is produced. In this technology, however, since a low-frame-rate high-resolution image sequence and a high-frame-rate low-resolution image sequence are read simultaneously from the cameras and are utilized, the amount of data is increased and thus the power consumption is increased. Moreover, an expensive special compound sensor (camera) is required, and this makes this technology impracticable.

Moreover, another technology is proposed in which successive signals from the central part of an image sensor and signals obtained as a result of given signals being skipped throughout the entire region of the image sensor are alternately read according to specific applications. In this technology, the successive signals from the central part are read for use in autofocus control, and signals obtained as a result of given signals being skipped throughout the entire region are read for use in display. That is, this technology is limited in application and is not designed with it being kept in mind that moving images are shot.

### SUMMARY OF THE INVENTION

According to a first aspect of the present invention, there is provided an image sensing device including: an image acquisition portion that switches between a plurality of reading methods in which pixel signals of a group of light receiving pixels arranged in an image sensor are read and that thereby acquires, from the image sensor, a first image sequence formed such that a plurality of first images having a first resolution are arranged chronologically and a second image sequence formed such that a plurality of second images having a second resolution higher than the first resolution are arranged chronologically; and an output image sequence generation portion that generates, based on the first and second image sequences, an output image sequence formed such that a plurality of output images having the second resolution are arranged chronologically, in which a time interval between sequentially adjacent two output images among the plurality of output images is shorter than a time interval between sequentially adjacent two second images among the plurality of second images.

For example, the image sensing device may be configured as follows. The image sensing device further includes: an image compression portion that performs image compression on the output image sequence to generate compressed moving images including an intra-coded picture and a predictive-coded picture, the output image sequence composed of a first output image that is generated, according to a timing at which the first image is acquired, from the first image and the second image and a second output image that is generated, according to a timing at which the second image is acquired, from the second image. In the image sensing device, the image compression portion preferentially selects, as a target of the intra-coded picture, the second output image from the first and second output images and generates the compressed moving images.

For example, the image sensing device may be configured as follows. In the image sensing device, the image acquisition portion periodically and repeatedly performs an operation in which reading of the pixel signals for acquiring the first image from the image sensor and reading of the pixel signals for acquiring the second image from the image sensor are performed in a specified order, and thereby acquires the first and second image sequences.

For example, the image sensing device may be configured as follows. The image sensing device further includes: a shutter button through which an instruction is received to acquire a still image having the second resolution. In the image sensing device, based on the instruction received through the shutter button, the image acquisition portion switches between reading of the pixel signals for acquiring the first image from the image sensor and reading of the pixel signals for acquiring the second image from the image sensor, and performs the reading.

For example, the image sensing device may be configured as follows. The image sensing device further includes: a motion detection portion that detects a motion of an object on an image between different second images among the plurality of second images. In the image sensing device, based on the detected motion, the image acquisition portion switches between reading of the pixel signals for acquiring the first image from the image sensor and reading of the pixel signals for acquiring the second image from the image sensor, and performs the reading.

Specifically, for example, the image sensing device may be configured as follows. In the image sensing device, one or more first images are acquired during which sequentially adjacent two second images are acquired; the output image sequence generation portion includes a resolution conversion portion that generates third images by reducing a resolution of the second images to the first resolution; when a frame rate of the output image sequence is called a first frame rate and a frame rate of the second image sequence is called a second frame rate, the first frame rate is higher than the second frame rate; and the output image sequence generation portion generates, from the second image sequence, a third image sequence of the second frame rate by use of the resolution conversion portion, and thereafter generates the output image sequence of the first frame rate based on the second image sequence of the second frame rate and an image sequence of the first frame rate formed with the first and third image sequences.

For example, the image sensing device according to the first aspect of the invention may be configured as follows. In the image sensing device, the image acquisition portion reads the pixel signals from the image sensor such that the first image and the second image have the same field of view.

According to a second aspect of the present invention, there is provided a second image sensing device including: an image acquisition portion that switches between a plurality of reading methods in which pixel signals of a group of light receiving pixels arranged in an image sensor are read and that thereby acquires, from the image sensor, a first image sequence formed such that a plurality of first images having a first resolution are arranged chronologically and a second image sequence formed such that a plurality of second images having a second resolution higher than the first resolution are arranged chronologically; and a storage control portion that stores the first and second image sequences in a record medium such that the first images correspond to the second images.

According to another aspect of the present invention, there is provided an image processing device including: an output image sequence generation portion that generates, based on the stored contents of the record medium, an output image sequence formed such that a plurality of output images having a second resolution are arranged chronologically, in which a time interval between sequentially adjacent two output images among the plurality of output images is shorter than a time interval between sequentially adjacent two second images among a plurality of second images.

For example, in the image sensing device according to the second aspect of the invention, the image acquisition portion may read the pixel signals from the image sensor such that the first image and the second image have the same field of view.

The significance and effects of the present invention will be more apparent from the description of embodiments discussed below. The following embodiments are only used to describe the invention by way of example; the invention and the meanings of terms of components thereof are not limited to those described in the following embodiments.

### BRIEF DESCRIPTION OF THE DRAWINGS

FIG. 1 is an overall block diagram of an image sensing device according to a first embodiment of the present invention;

FIG. 2A is a diagram showing the arrangement of light receiving pixels of the image sensor shown in FIG. 1;

FIG. 2B is a diagram showing the effective region of the image sensor;

FIG. 3 is a diagram showing the arrangement of color filters disposed in the image sensor shown in FIG. 1;

FIG. 4 is a diagram showing how an original image is acquired by all-pixel reading;

FIG. 5 is a diagram showing how the original image is acquired by addition reading;

FIG. 6 is a diagram showing how the original image is acquired by skipping reading;

FIG. 7 is a diagram showing an image sequence composed of a high-resolution input image sequence and a low-resolution input image sequence that are obtained by controlling the switching of signal reading methods according to the first embodiment of the invention;

FIG. 8 is a partial block diagram of the image sensing device that includes an internal block diagram of a video signal processing portion according to the first embodiment of the invention;

FIG. 9 is a diagram showing how a high-resolution image sequence of a low frame rate and a low-resolution image sequence of a high frame rate are generated from the image sequence shown in FIG. 7;

FIG. 10 is a diagram showing a high-resolution output image sequence generated in a high-resolution processing portion shown in FIG. 8;

FIG. 11 is a flowchart showing the procedure of generating a high-resolution image by the high-resolution processing portion shown in FIG. 8;

FIG. 12 shows in detail an example of the internal configuration of the high-resolution processing portion shown in FIG. 8 and is a partial block diagram of the video signal processing portion shown in FIG. 8;

FIG. 13 is a diagram showing the configuration of MPEG moving images in a second embodiment of the invention;

FIG. 14 is a diagram showing an image sequence composed of a high-resolution input image sequence and a low-resolution input image sequence that are obtained by controlling the switching of signal reading methods according to a third embodiment of the invention;

FIG. 15 is a partial block diagram of the image sensing device that includes an internal block diagram of a video signal processing portion according to the third embodiment of the invention;

FIG. 16 is a diagram showing the first switching method of a signal switching method according to a fourth embodiment of the invention;

FIG. 17 is a diagram showing the second switching method of the signal switching method according to the fourth embodiment of the invention;

FIG. 18 is a diagram showing the third switching method of the signal switching method according to the fourth embodiment of the invention;

FIG. 19 is a schematic block diagram of a reproduction device according to a fifth embodiment of the invention;

FIG. 20 is a schematic block diagram of a reproduction device according to a sixth embodiment of the invention; and

FIG. 21 is a diagram showing the configuration of an image sensor employing a three-panel method.

### DETAILED DESCRIPTION OF PREFERRED EMBODIMENTS

Embodiments of the present invention will be specifically described below with reference to the accompanying drawings. In the referenced drawings, like parts are identified with like symbols, and their description will not be basically repeated.

### A First Embodiment

A first embodiment of the invention will be described. Second to sixth embodiments according to the invention, which will be described later, are based on the description of the first embodiment. Hence, the description of the first embodiment applies to the second to sixth embodiments unless they contradict each other.

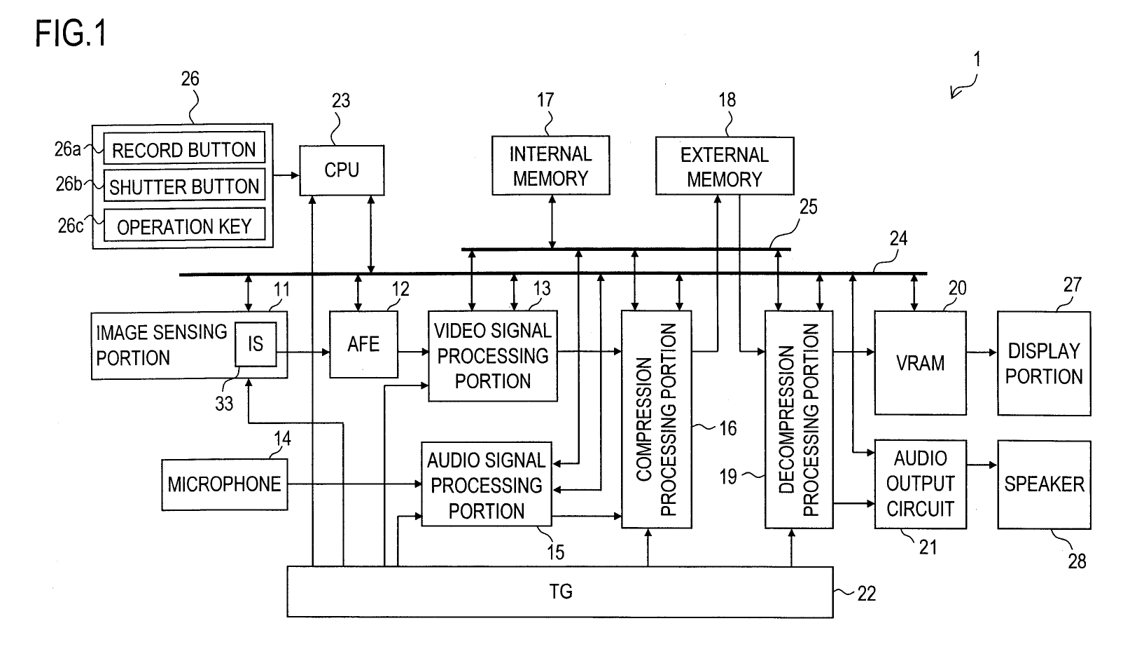

FIG. 1 is an overall block diagram of an image sensing device 1 according to the first embodiment of the invention. The image sensing device 1, for example, is a digital video camera. The image sensing device 1 can shoot moving images and a still image, and also can shoot moving images and a still image simultaneously.

### [Description of the Basic Configuration]

The image sensing device 1 is provided with an image sensing portion 11, an AFE (analog front end) 12, a video signal processing portion 13, a microphone 14, an audio signal processing portion 15, a compression processing portion 16, an internal memory 17 such as DRAM (dynamic random access memory), an external memory 18 such as a SD (secure digital) card or a magnetic disc, a decompression processing portion 19, a VRAM (video random access memory) 20, an audio output circuit 21, a TG (timing generator) 22, a CPU (central processing unit) 23, a bus 24, a bus 25, an operation portion 26, a display portion 27 and a speaker 28. The operation portion 26 has a record button 26a, a shutter button 26b, an operation key 26c and the like. The individual components of the image sensing device 1 exchange signals (data) therebetween via the bus 24 or the bus 25.

The TG 22 generates a timing control signal for controlling the timing of operations in the entire image sensing device 1, and feeds the generated timing control signal to the portions of the image sensing device 1. The timing control signal includes a vertical synchronization signal Vsync and a horizontal synchronization signal Hsync. The CPU 23 collectively controls the operations of the portions within the image sensing device 1. The operation portion 26 is operated by a user to receive the corresponding instruction. The instruction given to the operation portion 26 is transmitted to the CPU 23. The portions within the image sensing device 1 temporarily record, as required, various types of data (digital data) in the internal memory 17 during signal processing.

The image sensing portion 11 is provided with an image sensor 33, an unillustrated optical system, an aperture and a driver. Light incident from a subject enters the image sensor 33 via the optical system and the aperture. The lenses of the optical system form an optical image of the subject on the image sensor 33. The TG 22 generates a drive pulse that is synchronous with the timing control signal and that is used for driving the image sensor 33, and feeds the drive pulse to the image sensor 33.

The image sensor 33 is a solid-state image sensor that is formed with a CCD (charge coupled device), a CMOS (complementary metal oxide semiconductor) image sensor or the like. The image sensor 33 photoelectrically converts the optical image incident through the optical system and the aperture, and outputs an electrical signal obtained by the photoelectric conversion to the AFE 12. More specifically, the image sensor 33 has a plurality of light receiving pixels (not shown in FIG. 1) that are two-dimensionally arranged in a matrix; in a round of shooting, each light receiving pixel stores signal charge having an amount of electrical charge corresponding to the exposure time. Electrical signals from the light receiving pixels having a magnitude proportional to the amount of electrical charge of the stored signal charge are sequentially output to the AFE 12 in the subsequent stage according to the drive pulse from the TG 22.

The AFE 12 amplifies the analog signal output from the image sensor 33 (the light receiving pixels), converts the amplified analog signal into a digital signal and outputs the digital signal to the video signal processing portion 13. The signal amplification of the AFE 12 is controlled by the CPU 23. The video signal processing portion 13 performs various types of image processing on an image represented by the output signal of the AFE 12, and generates a video signal for an image on which the image processing has been performed. The video signal is typically composed of a brightness signal Y representing the brightness of the image and color-difference signals U and V representing the color of the image.

The microphone 14 converts ambient sound around the image sensing device 1 into an analog audio signal, and the audio signal processing portion 15 converts this analog audio signal into a digital audio signal.

The compression processing portion 16 compresses the video signal from the video signal processing portion 13 with a predetermined compression method. When moving images or a still image is shot and stored, the compressed video signal is stored in the external memory 18. The compression processing portion 16 also compresses the audio signal from the audio signal processing portion 15 with a predetermined compression method. When moving images are shot and stored, the video signal from the video signal processing portion 13 and the audio signal from the audio signal processing portion 15 are compressed by the compression processing portion 16 such that they are related in time to each other, and thereafter the compressed signals are stored in the external memory 18.

The record button 26a is a push-button switch with which an instruction is given to shoot moving images or to start or complete recording; the shutter button 26b is a push-button switch with which an instruction is given to shoot and record a still image.

The operation modes of the image sensing device 1 include a shooting mode in which moving images and a still image can be shot and a reproduction mode in which moving images and a still image stored in the external memory 18 are reproduced and displayed on the display portion 27. The modes are switched according to the operation performed on the operation key 26c.

In the shooting mode, shooting is sequentially performed every defined frame period, and an image sequence that is shot is received from the image sensor 33. As is well known, the reciprocal of a frame period is referred to as a frame rate. The image sequence such as an image sequence that is shot refers to a sequence of images arranged in chronological order. The data that represents an image is referred to as image data. The image data can also be considered as one type of video signal. An image per sheet is represented by image data per frame period. The video signal processing portion 13 performs various types of image processing on the image represented by the output signal of the AFE 12; the image that has not been subjected to the image processing and that is simply represented by the output signal of the AFE 12 is referred to as an original image. Hence, an original image per sheet is represented by the output signal of the AFE 12 per frame period.

In the shooting mode, when the user presses down the record button 26a, under the control of the CPU 23, video signals obtained after the record button 26a is pressed down and the corresponding audio signals are sequentially recorded in the external memory 18 through the compression processing portion 16. After the start of the shooting of moving images, when the user presses down the record button 26a again, the recording of the video signals and the audio signals in the external memory 18 is finished, with the result that the shooting of a series of moving images is completed. In the shooting mode, when the user presses down the shutter button 26b, a still image is shot and recorded.

In the reproduction mode, when the user performs a predetermined operation on the operation key 26c, the compressed video signal that represents moving images or a still image recorded in the external memory 18 is decompressed by the decompression processing portion 19 and is stored in the VRAM 20. In the reproduction mode, irrespective of operations that are performed on the record button 26a and the shutter button 26b, video signals are sequentially produced by the video signal processing portion 13 and are stored in the VRAM 20 on a general basis.

The display portion 27 is a display device such as a liquid crystal display, and displays an image corresponding to the video signal stored in the VRAM 20. When moving images are reproduced in the reproduction mode, the compressed audio signal corresponding to moving images stored in the external memory 18 is also fed to the decompression processing portion 19. The decompression processing portion 19 decompresses the received audio signal and feeds it to the audio output circuit 21. The audio output circuit 21 converts the received digital audio signal into an audio signal (for example, an analog audio signal) in a form that can be output from the speaker 28, and outputs it to the speaker 28. The speaker 28 outputs the audio signal from the audio output circuit 21 as audio (sound) to the outside.

For ease of description, in the following description, even when data are compressed or decompressed, the compression or decompression of data may be disregarded. For example, although, in order for an image to be reproduced from compressed image data and displayed, it is necessary to decompress the image data, the discussion on the decompression of the image data may be omitted in the following description.

### [Arrangement of Light Receiving Pixels of the Image Sensor]

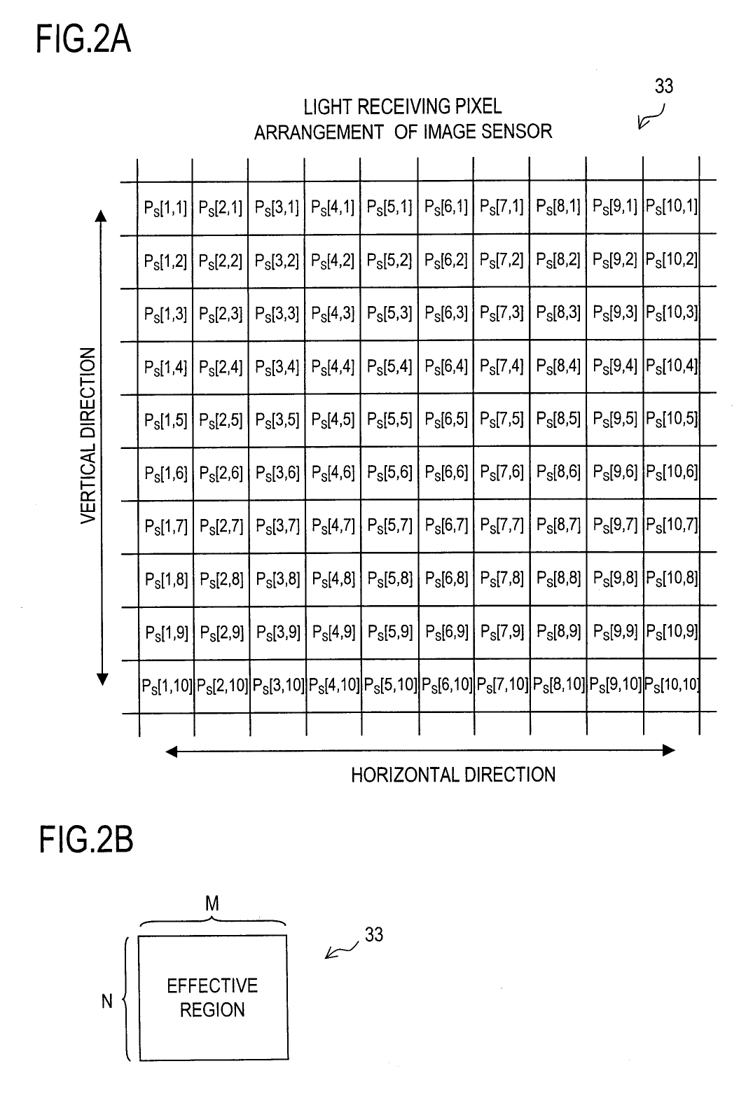

FIG. 2A shows the arrangement of light receiving pixels within the effective region of the image sensor 33. The effective region of the image sensor 33 is rectangular in shape; one vertex of the rectangle is defined as the origin of the image sensor 33. The origin is assumed to be disposed at the upper left corner of the effective region of the image sensor 33. As shown in FIG. 2B, the light receiving pixels corresponding in number to the product (M×N) of the number of effective pixels M in a horizontal direction of the image sensor 33 and the number of effective pixels N in a vertical direction thereof are two-dimensionally arranged, and thus the effective region of the image sensor 33 is formed. The light receiving pixels within the effective region of the image sensor 33 are represented as Pₛ [x, y] where x and y represent an integer and satisfy inequalities “1≦x≦M” and “1≦y≦N”, M and N each represent an integer equal to or greater than 2 and M and N each fall within the range of, for example, a few hundreds to a few thousands. It is assumed that, as the light receiving pixels are located closer to the right side as seen from the origin of the image sensor 33, they have a greater value of the variable x accordingly, and that, as the light receiving pixels are located closer to the lower side, they have a greater value of the variable y accordingly. In the image sensor 33, the upward and downward direction corresponds to the vertical direction, and the lateral direction corresponds to the horizontal direction.

FIG. 2A shows a total of 100 light receiving pixels Pₛ [x, y] that satisfy the inequalities “1≦x≦10” and “1≦y≦10.” Among the light receiving pixels shown in FIG. 2A, the position of the light receiving pixel P, [1, 1] is closest to the origin of the image sensor 33, and the position of the light receiving pixel P, [10, 10] is the farthest from the origin of the image sensor 33.

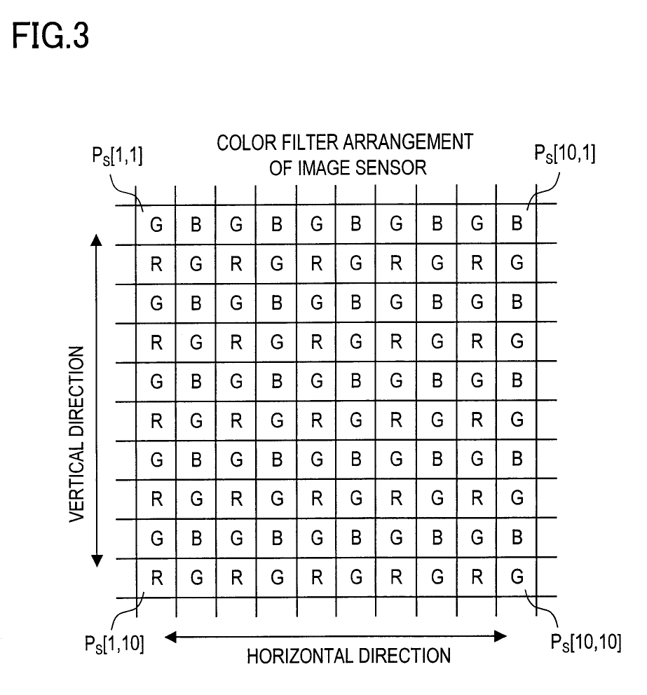

The image sensing device 1 employs a so-called single panel method in which only one image sensor is used. FIG. 3 shows the arrangement of color filters disposed on the front surfaces of the light receiving pixels of the image sensor 33. The arrangement shown in FIG. 3 is generally called a Bayer arrangement. Color filters are classified into a red filter that transmits only the red component of light, a green filter that transmits only the green component of light and a blue filter that transmits only the blue component of light. The red filter is disposed on the front surface of light receiving pixel Pₛ [2n_{A}−1, 2n_{B}], the blue filter is disposed on the front surface of light receiving pixel Pₛ [2n_{A}, 2n_{B}−1] and the green filter is disposed on the front surface of light receiving pixel Pₛ [2n_{A}−1, 2n_{B}−1] or the light receiving pixel Pₛ [2n_{A}, 2n_{B}] where n_{A} and n_{B} represent an integer. In FIG. 3 and FIGS. 4 to 6 that will be described later, parts corresponding to the red filter are represented by R, parts corresponding to the green filter are represented by G and parts corresponding to the blue filter are represented by B.

The light receiving pixels having a front surface on which the red filter, the green filter and the blue filter are disposed are referred to as a red light receiving pixel, a green light receiving pixel and a blue light receiving pixel, respectively. The light receiving pixels photoelectrically convert light entering them through the color filters into electrical signals. These electrical signals represent pixel signals for the light receiving pixels, and they are also hereinafter referred to as “light receiving pixel signals.” The red light receiving pixel, the green light receiving pixel and the blue light receiving pixel respond to only the red, green and blue components, respectively, of light incident through the optical system.

### [Method of Reading a Light Receiving Pixel Signal]

As the method of reading a light receiving pixel signal from the image sensor 33, there are an all-pixel reading method in which light receiving pixel signals are individually read from all the light receiving pixels disposed within the effective region of the image sensor 33, an addition reading method in which signals obtained by adding together a plurality of light receiving pixel signals are read and a skipping reading method in which signals obtained as a result of given pixel signals being skipped are read. For ease of description, in the following description, the amplification and digitization of signals by the AFE 12 are disregarded.

### All-Pixel Reading Method

The all-pixel reading method will be described. When light receiving pixel signals are read from the image sensor 33 with the all-pixel reading method, the light receiving pixel signals from all light receiving pixels disposed within the effective region of the image sensor 33 are individually fed through the AFE 12 to the video signal processing portion 13.

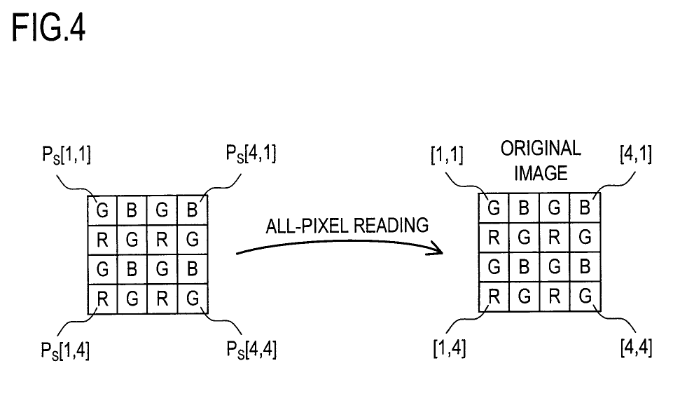

Thus, when the all-pixel reading method is employed, as shown in FIG. 4, (4×4) light receiving pixel signals of 4×4 light receiving pixels serve as (4×4) pixel signals of 4×4 pixels on the original image. The 4×4 light receiving pixels refer to a total of 16 light receiving pixels in which 4 light receiving pixels in a horizontal direction and 4 light receiving pixels in a vertical direction are arranged in a matrix The same applies to the 4×4 pixels.

When the all-pixel reading method is employed, as shown in FIG. 4, the light receiving pixel signal of the light receiving pixel Pₛ [x, y] serves as the pixel signal of the pixel at a pixel position [x, y] on the original image. In a given image of interest including the original image, the position on the image of interest where a pixel is disposed is referred to as the pixel position and is also represented by the symbol [x, y]. It is assumed that, as pixels on the image of interest are located closer to the right side as seen from the origin of the image of interest disposed at the upper left corner of the image of interest, they have a greater value of the variable x accordingly, and that, as pixels on the image of interest are located closer to the lower side, they have a greater value of the variable y accordingly. In the image of interest, the upward and downward direction corresponds to the vertical direction, and the lateral direction corresponds to the horizontal direction.

In the original image, a pixel signal of any one of a red component, a green component and a blue component is present for one pixel position. In a given image of interest including the original image, pixel signals representing data on the red component, the green component and the blue component are referred to as R signals, G signals and B signals, respectively.

When the all-pixel reading method is employed, the pixel signal of a pixel disposed at a pixel position [2n_{A}−1, 2n_{B}] on the original image is the R signal, the pixel signal of a pixel disposed at a pixel position [2n_{A}, 2n_{B}−1] on the original image is the B signal and the pixel signal of a pixel disposed at a pixel position [2n_{A}−1, 2n_{B}−1] or a pixel position [2n_{A}, 2n_{B}] on the original image is the G signal.

### Addition Reading Method

The addition reading method will be described. When light receiving pixel signals are read from the image sensor 33 with the addition reading method, an addition signal obtained by adding together a plurality of light receiving pixel signals is fed through the AFE 12 from the image sensor 33 to the video signal processing portion 13, and the pixel signal of one pixel on the original image is produced by one addition signal.

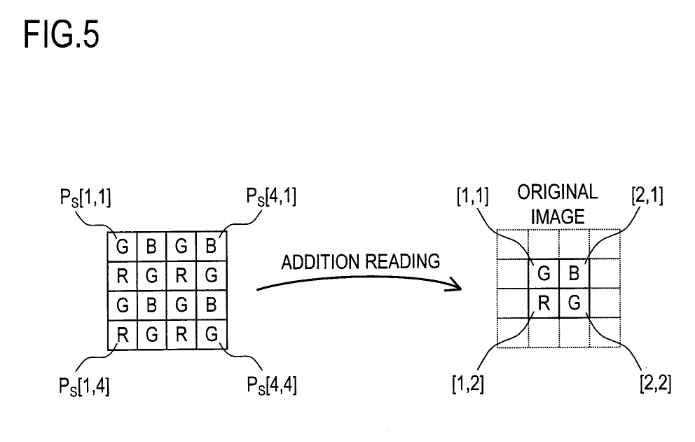

There are various types of methods of adding together light receiving pixel signals, and how the original image is acquired by using the addition reading method is shown as an example in FIG. 5. In the example shown in FIG. 5, in order for one addition signal to be produced, four light receiving pixel signals are added together. In this addition reading method, the effective region of the image sensor 33 is divided into a plurality of small light receiving pixel regions. Each of the small light receiving pixel regions is composed of 4×4 light receiving pixels; four addition signals are produced from one small light receiving pixel region. The four addition signals produced in each small light receiving pixel region are read as the pixel signals of pixels on the original image.

For example, when a small light receiving pixel region composed of light receiving pixels Pₛ [1, 1] to Pₛ [4, 4] is considered, an addition signal obtained by adding together light receiving pixel signals of light receiving pixels Pₛ [1, 1], Pₛ [3, 1], Pₛ [1, 3] and Pₛ [3, 3] is read from the image sensor 33 as the pixel signal (G signal) at the pixel position [1, 1] on the original image, an addition signal obtained by adding together light receiving pixel signals of light receiving pixels Pₛ [2, 1], Pₛ[4, 1], Pₛ[2, 3] and Pₛ[4, 3] is read from the image sensor 33 as the pixel signal (B signal) at the pixel position [2, 1] on the original image, an addition signal obtained by adding together light receiving pixel signals of light receiving pixels Pₛ[1, 2], Pₛ[3, 2], Pₛ[1, 4] and Pₛ [3, 4] is read from the image sensor 33 as the pixel signal (R signal) at the pixel position [1, 2] on the original image and an addition signal obtained by adding together light receiving pixel signals of light receiving pixels Pₛ[2, 2], Pₛ [4, 2], Pₛ[2, 4] and Pₛ[4, 4] is read from the image sensor 33 as the pixel signal (G signal) at the pixel position [2, 2] on the original image.

The reading using the above-described addition reading method is performed on each small light receiving pixel region. In this way, the pixel signal of the pixel disposed at the pixel position [2n_{A}−1, 2n_{B}] on the original image becomes the R signal, the pixel signal of the pixel disposed at the pixel position [2n_{A}, 2n_{B}−1] on the original image becomes the B signal and the pixel signal of the pixel disposed at the pixel position [2n_{A}−1, 2n_{B}−1] or the pixel position [2n_{A}, 2n_{B}] on the original image becomes the G signal.

### Skipping Reading Method

The skipping reading method will be described. When light receiving pixel signals are read from the image sensor 33 with the skipping reading method, some light receiving pixel signals are skipped. Specifically, among all the light receiving pixels within the effective region of the image sensor 33, light receiving pixel signals of some light receiving pixels are only fed through the AFE 12 from the image sensor 33 to the video signal processing portion 13. The pixel signal of one pixel on the original image is formed by one light receiving pixel signal fed to the video signal processing portion 13.

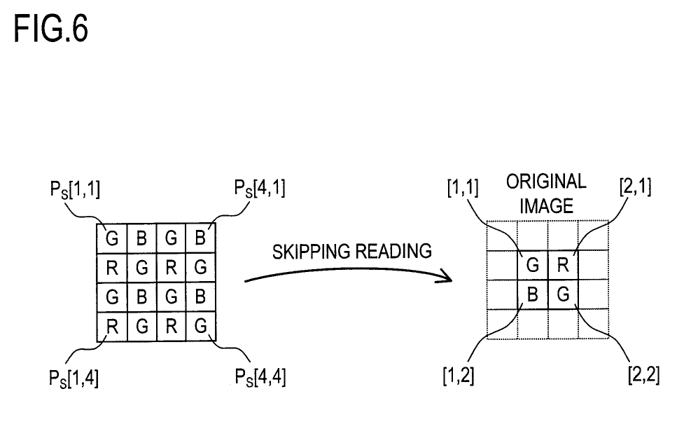

There are various types of methods of skipping light receiving pixel signals, and how the original image is acquired by using the skipping reading method is shown as an example in FIG. 6. In this example, the effective region of the image sensor 33 is divided into a plurality of small light receiving pixel regions. Each of the small light receiving pixel regions is composed of 4×4 light receiving pixels. Only four light receiving pixel signals are read from one small light receiving pixel region as pixel signals of pixels on the original image.

For example, when a small light receiving pixel region composed of light receiving pixels Pₛ [1, 1] to Pₛ [4, 4] is considered, the light receiving pixel signals of light receiving pixels Pₛ [2, 2], Pₛ [3, 2], Pₛ [2, 3] and Pₛ [3, 3] are read from the image sensor 33 as pixel signals at pixel positions [1, 1], [2, 1], [1, 2] and [2, 2] on the original image, respectively. The pixel signals at pixel positions [1, 1], [2, 1], [1, 2] and [2, 2] on the original image are the G signal, the R signal, the B signal and the G signal, respectively.

The reading using the above-described skipping reading method is performed on each small light receiving pixel region. In this way, the pixel signal of the pixel disposed at the pixel position [2n_{A}−1, 2n_{B}] on the original image becomes the B signal, the pixel signal of the pixel disposed at the pixel position [2n_{A}, 2n_{B}−1] on the original image becomes the R signal and the pixel signal of the pixel disposed at the pixel position [2n_{A}−1, 2n_{B}−1] or the pixel position [2n_{A}, 2n_{B}] on the original image becomes the G signal.

Reading signals with the all-pixel reading method, the addition reading method, or the skipping reading method is hereinafter referred to as all-pixel reading, addition reading or skipping reading, respectively. In the following description, when the addition reading method or the addition reading is simply mentioned, it refers to the addition reading method or the addition reading described above with reference to FIG. 5; when the skipping reading method or the skipping reading is simply mentioned, it refers to the skipping reading method or the skipping reading described above with reference to FIG. 6.

The original image acquired by the all-pixel reading and the original image acquired by the addition reading or the skipping reading have the same field of view. Specifically, if the image sensing device 1 and the subject are stationary while both the original images are shot, both the original images represent the same image of the subject.

However, the size of the original image acquired by the all-pixel reading is (M×N), and the size of the original image acquired by the addition reading or the skipping reading is (M/2×N/2). Specifically, the number of pixels in a horizontal direction of and the number of pixels in a vertical direction of the original image acquired by the all-pixel reading are M and N, respectively, whereas the number of pixels in a horizontal direction of and the number of pixels in a vertical direction of the original image acquired by the addition reading or the skipping reading are M/2 and N/2, respectively. As described above, the original image acquired by the all-pixel reading differs in resolution from that acquired by the addition reading or the skipping reading, and the resolution of the former is twice that of the latter in horizontal and vertical directions.

Even when any of the reading methods is employed, the R signals are disposed in mosaic form on the original image. The same applies to the B and G signals. The video signal processing portion 13 shown in FIG. 1 can perform, on the original image, color interpolation called demosaicing processing to produce a color interpolated image from the original image. In the color interpolated image, the R, G and B signals are all present for one pixel position or the brightness signal Y and the color-difference signals U and V are all present for one pixel position.

### [Method of Obtaining High/Low Resolution Images]

In the following description, the original image acquired by the all-pixel reading is referred to as a high-resolution input image, and the original image acquired by the addition reading or the skipping reading is referred to as a low-resolution input image. Alternatively, it is possible not only to handle, as the high-resolution input image, a color interpolated image acquired by performing the color interpolation on the original image acquired by the all-pixel reading but also to handle, as the low-resolution input image, a color interpolated image acquired by performing the color interpolation on the original image acquired by the addition reading or the skipping reading. In the following description, the high-resolution image refers to an image having the same resolution as that of the high-resolution input image, and the low-resolution image refers to an image having the same resolution as that of the low-resolution input image. The high-resolution input image is one type of high-resolution image; the low-resolution input image is one type of low-resolution image.

In this specification, the high-resolution input image or the like may be abbreviated by suffixing a sign (symbol). For example, in the following description, when a symbol H₁ is assigned to represent a given high-resolution input image, the high-resolution input image H₁ may be simply abbreviated as the image H₁, with the result that they represent the same.

The image sensor 33 is formed such that it can read signals with the all-pixel reading method and that it can also read signals with the addition reading method and/or the skipping reading method. The CPU 23 shown in FIG. 1 cooperates with the TG 22 to control the image sensor 33, and thereby determines which reading method is used so as to acquire the original image. In the following description including the description of the other embodiments, which will be discussed later, in order to give the specific and simplified description, the addition reading method is assumed to be used as a reading method for obtaining the low-resolution input image. However, the skipping reading method may be used as a reading method for obtaining the low-resolution input image; when the skipping reading method is used, it is advisable that the terms “addition reading method” and “addition reading” which will be used later in the description of the embodiments be read as the terms “skipping reading method” and “the skipping reading.”

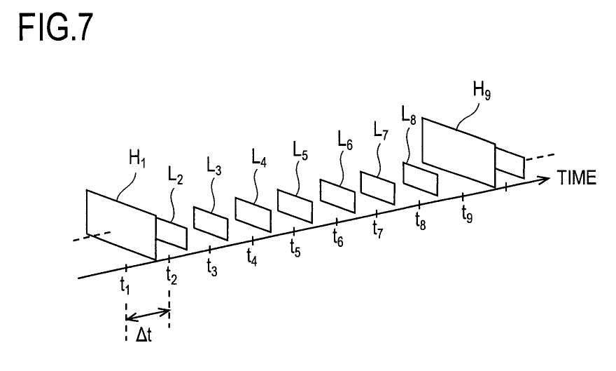

In the first embodiment, the all-pixel reading and the addition reading are performed in a specified order. Specifically, a series of operations in which the all-pixel reading is performed once to read pixel signals for one frame and then the addition reading for reading pixel signals for one frame is continuously performed “L_{NUM}” times is repeated periodically. L_{NUM} represents an integer equal to or greater than one. Here, consider a case where L_{NUM} is seven. An image sequence obtained by performing this reading is shown in FIG. 7.

Timings t₁, t₂, t₃, t₄, t₅, t₆, t₇, t₈, t₉, . . . are assumed to be sequentially given in this order. The all-pixel reading is performed once at timing t₁, and the first, second, third, fourth, fifth, sixth and seventh rounds of the addition reading are performed at timings t₂, t₃, t₄, t₅, t₆, t₇ and t₈, respectively. A series of operations composed of the one round of the all-pixel reading and the seven rounds of the addition reading is performed at given periods. Thus, the subsequent round of the all-pixel reading after the all-pixel reading is performed at timing t₁ is performed at timing t₉, and then the addition reading is performed seven times, staring at timing too succeeding timing t₉.

Here, the high-resolution input images obtained by performing the all-pixel reading at timings t₁ and t₉ are represented by H₁ and H₉, respectively; the low-resolution input images obtained by performing the addition reading at timings t₂, t₃, t₄, t₅, t₆, t₇ and t₈ are represented by L₂, L₃, L₄, L₅, L₆, L₇ and L₈, respectively.

A period between timing tᵢ and timing tᵢ₊₁ is referred to as a unit period Δt. Here, the letter “i” represents an integer equal to or greater than one. The unit period Δt is constant irrespective of the value of the letter “i.” Strictly speaking, timing tᵢ, for example, refers to a starting time for a period during which a pixel signal for an input image (a high-resolution input image or a low-resolution input image) obtained at timing tᵢ is read from the image sensor 33. Thus, timing t₁, for example, refers to a starting time for a period during which a pixel signal for the high-resolution input image H₁ is read from the image sensor 33. A starting time, an intermediate time or a completion time for an exposure period for the input image obtained at timing tᵢ may be assumed to be timing tᵢ.

### [Configuration and Operation of the Video Signal Processing Portion]

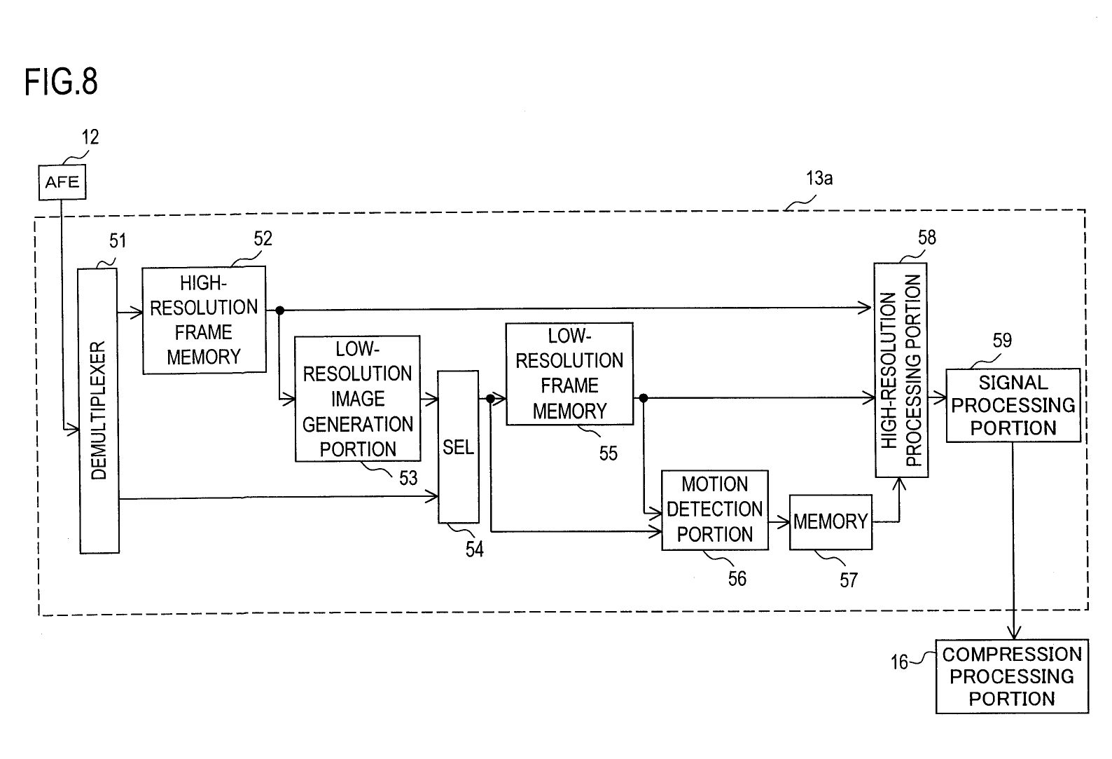

The configuration and the operation of the video signal processing portion 13 shown in FIG. 1 will now be described. FIG. 8 is a partial block diagram of the image sensing device 1 that includes an internal block diagram of a video signal processing portion 13a serving as the video signal processing portion 13. The video signal processing portion 13a is provided with portions represented by reference numerals 51 to 59. The whole or part of a high-resolution frame memory 52, a low-resolution frame memory 55 and a memory 57 may be formed with the internal memory 17 shown in FIG. 1.

Image data on the high-resolution input image and the low-resolution input image from the AFE 12 is fed to a demultiplexer 51. When the image data fed to the demultiplexer 51 is the image data on the low-resolution input image, the image data is fed through a selection portion 54 to the low-resolution frame memory 55 and a motion detection portion 56. The low-resolution frame memory 55 stores the image data on a low-resolution image fed through the selection portion 54.

When the image data fed to the demultiplexer 51 is the image data on the high-resolution input image, the image data is temporarily stored in the high-resolution frame memory 52, and is then output to a low-resolution image generation portion 53 and a high-resolution processing portion 58. The low-resolution image generation portion 53 converts the high-resolution input image stored in the high-resolution frame memory 52 such that the high-resolution input image has lower resolution, thereby generates the low-resolution image and outputs the generated low-resolution image to the selection portion 54. Thus, when the image data fed to the demultiplexer 51 is the image data on the high-resolution input image, the image data on the low-resolution image based on the high-resolution input image is fed through the selection portion 54 to the low-resolution frame memory 55 and the motion detection portion 56.

The low-resolution image generation portion 53 reduces the size of the high-resolution input image by half in both horizontal and vertical directions, and thereby produces the low-resolution image. This generation method is the same as the method of generating the original image of (M/2×N/2) pixel signals from (M×N) light receiving pixel signals for the effective region in the image sensor 33. Specifically, an addition signal is generated by adding together a plurality of pixel signals included in all pixel signals for the high-resolution input image, and an image of the addition signal serving as a pixel signal is generated to produce the low-resolution image. Alternatively, by skipping some of all pixel signals for the high-resolution input image, the low-resolution image is generated.

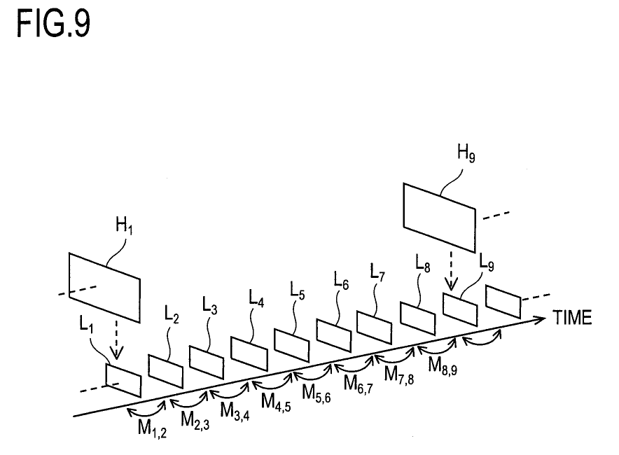

The low-resolution images generated by the low-resolution image generation portion 53 from the high-resolution input images H₁ and H₉ are represented by L₁ and L₉, respectively, and the low-resolution images L₁ and L₉ are considered to be low-resolution images at timings t₁ and t₉. Thus, as shown in FIG. 9, a low-resolution image sequence composed of the images L₁ and L₉ is generated from a high-resolution input image sequence composed of the images H₁ and H₉; the combination of the low-resolution image sequence composed of the images L₁ and L₉ and a low-resolution input image sequence composed of images L₂ to L₈ generates a low-resolution image sequence composed of the images L₁ to L₉.

The frame rate of the low-resolution image sequence composed of the images L₁ to L₉ is relatively high; the frame rate is the reciprocal of a period (that is, the unit period Δt) between timing tᵢ and timing tᵢ₊₁. On the other hand, the frame rate of the high-resolution input image sequence composed of the images H₁ and H₉ (and the low-resolution image sequence composed of the images L₁ and L₉) is relatively low; the frame rate is the reciprocal of a period (8×Δt) between timing t₁ and timing t₉. As described above, in the video signal processing portion 13a, the high-resolution, low-frame-rate image sequence composed of the images H₁ and H₉ and the low-resolution, high-frame-rate image sequence composed of the images L₁ to L₉ are generated.

Based on the image data on the low-resolution image stored in the low-resolution frame memory 55 and the image data on the low-resolution image fed from the selection portion 54, the motion detection portion 56 determines an optical flow between the two low-resolution images that are compared. As a method for determining an optical flow, a block matching method, a representative point matching method, a gradient method or the like can be used. The determined optical flow is represented by a motion vector representing the motion of a subject (object) on an image between the two low-resolution images that are compared. The motion vector is a two-dimensional quantity that indicates the direction and magnitude of the motion. The motion detection portion 56 stores, as the result obtained by motion detection, the determined optical flow in the memory 57.

The motion detection portion 56 detects the motion between adjacent frames. The result obtained by motion detection between the adjacent frames, that is, a motion vector determined from the images Lᵢ and Lᵢ₊₁, is represented by M_{i, i+1} (“i” is an integer equal to or greater than one). While the motion vector between the images Lᵢ and Lᵢ₊₁ is determined, when image data on another image (for example, an image Lᵢ₊₂) is output from the selection portion 54, the image data on the image is temporarily stored in the low-resolution frame memory 55 so that the image data on the image can be referenced later. Only the necessary part of the result obtained by motion detection between the adjacent frames is preferably stored in the memory 57. For example, when the result obtained by motion detection between the images L₁ and L₂, the result obtained by motion detection between the images L₂ and L₃ and the result obtained by motion detection between the images L₃ and L₄ are stored in the memory 57, and are then read from the memory 57 and combined together, it is possible to determine an optical flow (a motion vector) between any two images among the images L₁ to L₄.

Based on the high-resolution image sequence that is fed through the high-resolution frame memory 52 and that is composed of a plurality of high-resolution input images including the images H₁ and H₉, the low-resolution image sequence that is fed through the low-resolution frame memory 55 and that is composed of a plurality of low-resolution images including the images L₁ to L₉ and the result that is obtained by the motion detection and that is stored in the memory 57, the high-resolution processing portion 58 generates a high-resolution output image sequence.

The signal processing portion 59 generates video signals for high-resolution output images that constitute the high-resolution output image sequence. These video signals are composed of the brightness signal Y and the color-difference signals U and V. The video signal generated by the signal processing portion 59 is fed to the compression processing portion 16, where the video signal is compressed and encoded. The high-resolution output image sequence can also be reproduced and displayed as moving images on the display portion 27 shown in FIG. 1 or on an external display device (not shown) for the image sensing device 1.

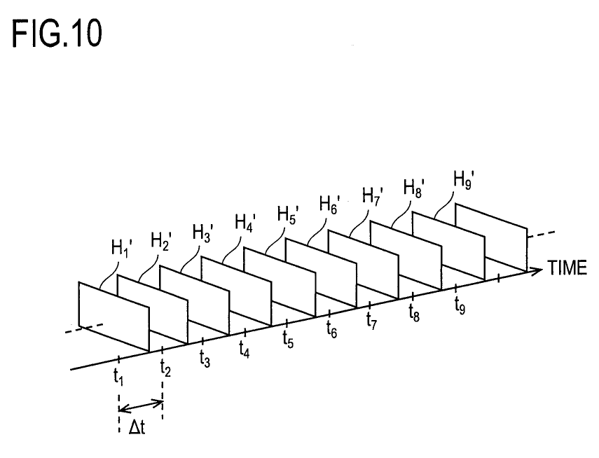

FIG. 10 shows the high-resolution output image sequence output from the high-resolution processing portion 58. The high-resolution output image sequence includes a plurality of high-resolution output images H₁′ to H₉′ that are arranged chronologically. The images H₁′ to H₉′ are the high-resolution output images at timings ti to t₉, respectively. The high-resolution input images H₁ and H₉ can be utilized as the high-resolution output images H₁′ and H₉′ without being processed. The frame rate of the high-resolution output image sequence is relatively high; the frame rate is the same as that of the low-resolution image sequence composed of the images L₁ to L₉. Moreover, the resolution of the high-resolution output image is the same as that of the high-resolution input image (therefore, the numbers of pixels of the high-resolution output image in horizontal and vertical directions are M and N, respectively).

As a method for generating the high-resolution output image sequence having a relatively high frame rate based on a high-resolution image sequence having a relatively low frame rate and a low-resolution image sequence having a relatively high frame rate, any method including a known method (a method that is disclosed in JP-A-2005-318548) can be employed.

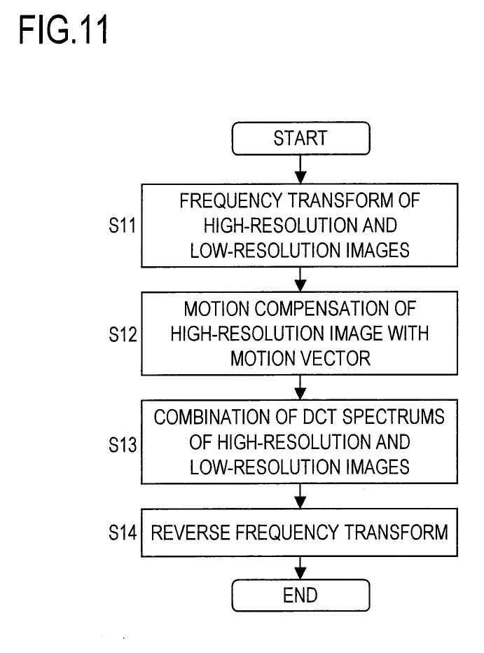

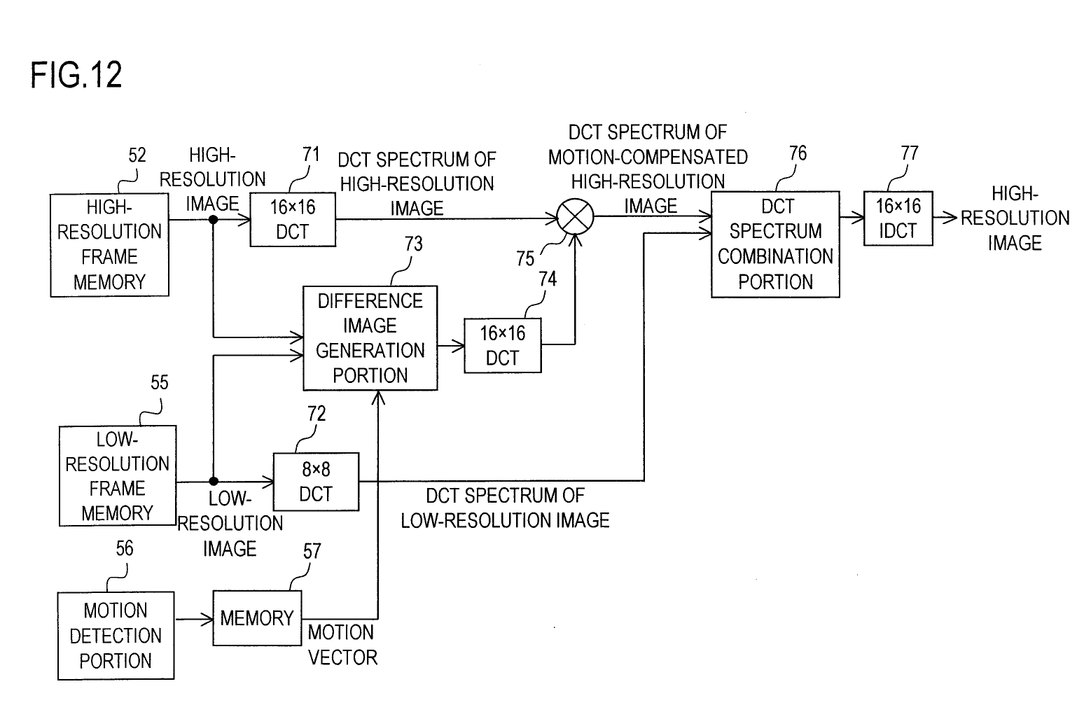

As an example of a method for generating the high-resolution output image sequence, a method using a two-dimensional discrete cosine transform (“discrete cosine transform” is hereinafter referred to as “DCT”) that is one type of frequency transform will be shown below with reference to FIGS. 11 and 12. Although, in this example, the two-dimensional DCT, which is one type of orthogonal transform, is used as an example of frequency transform, instead of the two-dimensional DCT, any other type of orthogonal transform may be used such as wavelet transform, Walsh-Hadamard transform, discrete Fourier transform, discrete sine transform, Haar transform, Slant transform or Karhunen-Loeve transform.

The high-resolution image that is generated by the high-resolution image generation method using DCT will also be hereinafter referred to simply as a generated image. In the high-resolution image generation method using DCT, a high-frequency component and a low-frequency component included in the generated image are estimated by different methods. As the high-frequency component of the generated image, the DCT spectrum of the high-resolution image that has been motion-compensated on a spatial domain (an image spatial domain) is utilized without being processed. The spectrum of part that cannot be motion-compensated is generated by interpolation from the low-resolution image. Specifically, the low-frequency component of the generated image is generated by combing the DCT spectrum of the high-resolution image that has been motion-compensated on the spatial domain with the DCT spectrum of the low-resolution image.

FIG. 11 is a flowchart of the high-resolution image generation method using DCT. First, in step S11, frequency transform for transforming the high-resolution image and the low-resolution image represented on the spatial domain into the high-resolution image and the low-resolution image represented on the frequency domain is performed by use of the two-dimensional DCT. Thus, the DCT spectrums of the high-resolution image and the low-resolution image that represent the high-resolution image and the low-resolution image represented on the frequency domain are generated. Then, in step S12, the high-resolution image is motion-compensated by use of a motion vector. Thereafter, in step S13, the DCT spectrums of the high-resolution image and the low-resolution image are combined. Finally, in step S14, reverse frequency transform, that is, the reverse transform of the above-described frequency transform is performed on the combined spectrum. That is, the image on the frequency domain represented by the combined spectrum is transformed into the image on the spatial domain. In this way, the high-resolution image is generated on the spatial domain.

FIG. 12 is a partial block diagram of the video signal processing portion 13a when the high-resolution image generation method shown in FIG. 11 is employed. Portions represented by reference numerals 71 to 77 shown in FIG. 12 are provided in the high-resolution processing portion 58 shown in FIG. 8. The processing in step S11 is performed by the DCT portions 71 and 72; the processing in step S12 is performed by the difference image generation portion 73, the DCT portion 74 and the adder portion 75; the processing in step S13 is performed by the DCT spectrum combination portion 76; and the processing in step S14 is performed by the IDCT portion 77.

The DCT portion 71 performs the two-dimensional DCT on the high-resolution image stored in the high-resolution frame memory 52 to generate the DCT spectrum of the high-resolution image for each high-resolution image stored in the high-resolution frame memory 52. Likewise, the DCT portion 72 performs the two-dimensional DCT on the low-resolution image stored in the low-resolution frame memory 55 to generate the DCT spectrum of the low-resolution image for each low-resolution image stored in the low-resolution frame memory 55. In this example, the two-dimensional DCT on the high-resolution image is performed in blocks of 16×16 pixels. On the other hand, as described previously, the size of the high-resolution image in horizontal and vertical directions is twice that of the low-resolution image. Thus, the two-dimensional DCT on the low-resolution image is performed in blocks of 8×8 pixels. The DCT spectrums of the images H₁ and H₉ are individually determined by the DCT portion 71; the DCT spectrums of the images L₁ to L₉ are individually determined by the DCT portion 72.

The motion vector stored in the memory 57 and the image data on the high-resolution image and the low-resolution image stored in the high-resolution frame memory 52 and the low-resolution frame memory 55 are input to the difference image generation portion 73. The high-resolution image that is generated in the high-resolution processing portion 58 (see FIG. 8) including the difference image generation portion 73 is referred to as a high-resolution purpose frame. The difference image generation portion 73 selects, among the high-resolution images stored in the high-resolution frame memory 52, a high-resolution image closest in time to the high-resolution purpose frame, and estimates, based on the selected high-resolution image (hereinafter, a closest selection image) and the motion vector stored in the memory 57, the high-resolution purpose frame that has been motion-compensated. Thereafter, a between-frame difference image between the estimated high-resolution purpose frame and the closest selection image is generated.

For example, when the image H₃′ shown in FIG. 10 is the high-resolution purpose frame, since the image H₁ is closer in time to the image H₃′ than the image H₉, the image H₁ is selected as the closest selection image. Thereafter, a combined vector M_{1, 3} is determined from motion vectors M_{1, 2} and M_{2, 3}, and the image obtained by displacing the position of objects within the image H₁ according to the combined vector M_{1, 3} is estimated as the motion-compensated high-resolution purpose frame. The difference image between the estimated high-resolution purpose frame and the selected image H₁ is generated as the between-frame difference image corresponding to the timing t₃. The same applies to a case where the image H₂′, H₄′, H₅′, H₆′, H₇′ or H₈′ is the high-resolution purpose frame. When the image H₂′ or H₄′ is the high-resolution purpose frame, the image H₁ is selected as the closest selection image; when the image H₆′ H₇′ or H₈′ is the high-resolution purpose frame, the image H₉ is selected as the closest selection image. When the image H₅′ is the high-resolution purpose frame, the image H₁ or H₉ is selected as the closest selection image.

The optical flow determined, by the motion detection portion 56, between two images is composed of a bunch of motion vectors in various positions on an image coordinate plane in which any image including a low-resolution image is defined. For example, the entire image regions of two images from which an optical flow is determined are individually divided into a plurality of partial image regions, and one motion vector is determined for each partial image region. When a motion vector is calculated for a given partial image region, if a plurality of motions are present within the partial image region, there is a possibility that a reliable motion vector cannot be calculated. For such a partial image region, a pixel signal for the high-resolution purpose frame is preferably estimated, by interpolation, from the low-resolution input image. For example, in a case where the image H₃′ is the high-resolution purpose frame, when the motion vectors M_{1, 2} and/or M_{2, 3} for a given partial image region have not been calculated, the pixel signal within the partial image region in the high-resolution purpose frame is preferably generated, by linear interpolation or the like, from the pixel signal within the partial image region in the image L₃.

The DCT portion 74 performs the two-dimensional DCT on the between-frame difference image generated in the difference image generation portion 73 to generate the DCT spectrum of the between-frame difference image. When attention is focused on timings t₁ to t₉, the between-frame difference image corresponding to each of timings t₂ to t₈ is generated. The DCT portion 74 generates the DCT spectrum for each between-frame difference image. In this example, the two-dimensional DCT on the between-frame difference image is performed in blocks of 16×16 pixels.

The adder portion 75 adds together the DCT spectrum of the high-resolution image (that is, the closest selection image) closest in time to the high-resolution purpose frame among the high-resolution images stored in the high-resolution frame memory 52 and the DCT spectrum of the between-frame difference image corresponding to the high-resolution purpose frame, in units of blocks (16×16 pixel blocks) for the two-dimensional DCT, with the result that the DCT spectrum of the motion-compensated high-resolution purpose frame is calculated.

The DCT spectrum combination portion 76 combines the DCT spectrum of the motion-compensated high-resolution purpose frame with the DCT spectrum of the low-resolution image generated by the DCT portion 72. When the high-resolution purpose frame is the image Hᵢ′, the low-resolution image to be combined is the image Lᵢ. This combination is naturally performed between the corresponding blocks. Thus, when the combination is performed on a given block of interest in the high-resolution purpose frame, the DCT spectrum of the block of interest in the motion-compensated high-resolution purpose frame is combined with the DCT spectrum, which is generated by the DCT portion 72, of a block within the low resolution image corresponding to the block of interest.

The combined spectrum obtained as a result of the DCT spectrum combination portion 76 performing combination represents the high-resolution purpose frame represented on the spatial domain. The IDCT portion 77 performs the two-dimensional IDCT (reverse discrete cosine transform) on the combined spectrum to generate the high-resolution purpose frame represented on the spatial domain (specifically, to determine a pixel signal for the high-resolution purpose frame on the spatial domain).

The processing described above is performed on all frames from which the high-resolution image has not been obtained. In this way, it is possible to generate the high-resolution output image sequence including the images H₁′ to H₉′ shown in FIG. 10.

When the all-pixel reading is always used in order to obtain the image sequence of a given specified frame rate, the power consumption of the image sensing device 1 is increased as compared with the case where the addition reading is always used. This is because, since the number of pixel signals read by the all-pixel reading is greater than the number of pixel signals read by the addition reading, in order to obtain the specified frame rate, it is necessary to increase the drive rate (the rate at which signals are read from the image sensor 33) of the image sensor 33 when the all-pixel reading is performed as compared with when the addition reading is performed. The increased drive rate of the image sensor 33 generally causes the power consumption to be increased. In order to achieve low power consumption and high frame rate, it is necessary to perform the addition reading (or the skipping reading) on pixel signals to decrease the amount of image data. However, when the addition reading (or the skipping reading) alone is simple performed, the resolution of moving images is degraded.

In consideration of this, as described above, the all-pixel reading and the addition reading (or the skipping reading) are performed in a specified order, and thus the low-frame-rate high-resolution image sequence and the high-frame-rate low-resolution image sequence are obtained, and then, from these image sequences, the high-frame-rate high-resolution image sequence is obtained by image processing. This makes it possible to generate the high-frame-rate high-resolution image sequence with low power consumption.

### Second Embodiment

The second embodiment of the present invention will be described. The basic configuration and the operation of an image sensing device according to the second embodiment are the same as those of the image sensing device 1 according to the first embodiment. The operation of the compression processing portion 16 will be described below that achieves a unique function in the second embodiment.

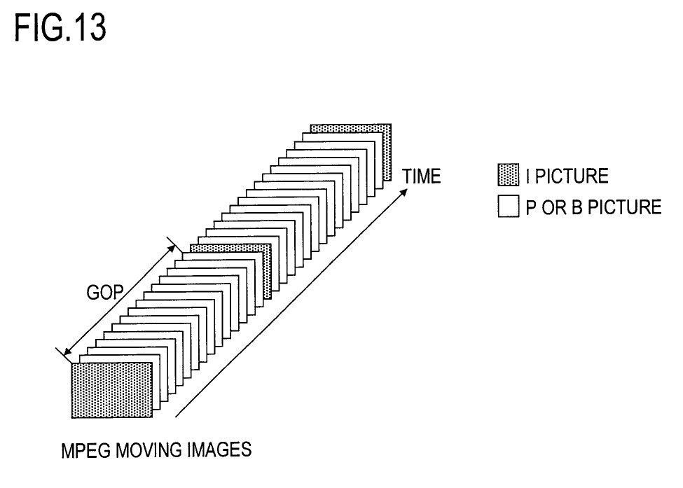

The compression processing portion 16 compresses not only video signals but also audio signals; here, a unique method of compressing video signals will be described. Consider a case where the compression processing portion 16 compresses video signals with the MPEG (moving picture experts group) compression method, which is a common method for compressing video signals. In the MPEG method, differences between frames are utilized, and thus MPEG moving images, which are moving images compressed, are generated. In FIG. 13, the configuration of the MPEG moving images is schematically shown. The MPEG moving images are composed of three types of pictures, namely, I pictures, P pictures and B pictures.

The I picture is an intra-coded picture; it is an image in which video signals of one frame are coded within the frame image. It is possible to decode the video signals of one frame with the I pictures alone.

The P picture is a predictive-coded picture; it is an image that is predicted from the preceding I picture or P picture. The P picture is formed by data that is obtained by compressing and coding the difference between the original image which is a target of the P picture and an I picture or a P picture preceding the P picture. The B picture is a bidirectionally predictive-coded picture; it is an image that is bidirectionally predicted from the succeeding and preceding I pictures or P pictures. The B picture is formed by data that is obtained by compressing and coding both the difference between the original picture which is a target of the B picture and an I picture or a P picture succeeding the B picture and the difference between the original picture which is the target of the B picture and an I picture or a P picture preceding the B picture.

The MPEG moving images are formed in units of a GOP (group of pictures). Compression and decompression are performed in units of a GOP; one GOP is composed of pictures from a given I picture to the succeeding I picture. The MPEG moving images are composed of one or two or more GOPs. The number of pictures from a given I picture to the succeeding I picture may be fixed or can be varied within a certain range.

When an image compression method utilizing the difference between frames, such as the MPEG method, is used, since the I picture supplies the difference data to both of the B and P pictures, the image quality of the I picture greatly affects the entire image quality of the MPEG moving images. On the other hand, the high-resolution image (such as the image H₁′) obtained by the all-pixel reading is higher in quality than the high-resolution image (such as the image H₂′) generated based on the low-resolution image. In consideration of this, the image number of the high-resolution image obtained by the all-pixel reading is recorded in the video signal processing portion 13 or the compression processing portion 16, and, when an image is compressed, the high-resolution output image corresponding to the recorded image number is preferentially utilized as a target of the I picture. Thus, it is possible to enhance the entire image quality of the MPEG moving images obtained by compression.

Specifically, when attention is focused on the images H₁′ to H₉′ shown in FIG. 10 and it is necessary to select two images among the images H₁′ to H₉′ as a target of the I picture, the images H₁′ and H₉′ are preferably selected as the target of the I picture. The ratio of the number H_{NUM} of high-resolution input images acquired to the number L_{NUM} of low-resolution input images acquired may be determined according to the number of pictures that constitute one GOP. For example, it is preferable that, when the number of pictures that constitute one GOP is eight, as shown in FIG. 7, H_{NUM}:L_{NUM}=1:7, whereas, when the number of pictures that constitute one GOP is ten, H_{NUM}:L_{NUM}=1:9.

The compression processing portion 16 codes, according to the MPEG compression method, the high-resolution output image that is selected as the target of the I picture to generate the I picture; it also generates the P and B pictures based on the high-resolution output image that is selected as the target of the I picture and the high-resolution output image that is not selected as the target of the I picture.

### Third Embodiment

The third embodiment of the present invention will be described. As shown in FIG. 7, in the first embodiment, the interval (for example, the interval between timing t₁ and timing t₂) between the acquisition of sequentially adjacent high-resolution input image and low-resolution input image is equal to the interval (for example, the interval between timing t₂ and timing t₃) between the acquisition of sequentially adjacent two low-resolution input images. However, in order to achieve this, it is necessary to increase the drive rate of the image sensor 33, and thus the power consumption is increased accordingly.

In order for such an increase in power consumption to be reduced, in the third embodiment, the interval between the acquisition of sequentially adjacent high-resolution input image and low-resolution input image is set longer than the interval between the acquisition of sequentially adjacent two low-resolution input images. Except that these two intervals are different, the basic configuration and the operation of an image sensing device according to the third embodiment are the same as those of the image sensing device 1 according to the first embodiment. However, due to the difference described above, the configuration of the video signal processing portion 13 is modified as appropriate. The difference between this embodiment and the first embodiment will be described below.

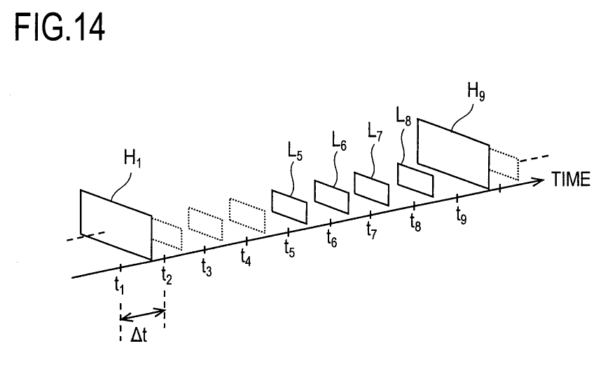

Reference is made to FIG. 14. A method of using the same drive rate (the rate at which signals are read from the image sensor 33) of the image sensor 33 in both the cases of the all-pixel reading and the addition reading will be described by way of example. Since the number of signals read from the image sensor 33 when the all-pixel reading is performed is considered to be four times that when the addition reading is performed, a period necessary to read pixel signals of one frame from the image sensor 33 by the all-pixel reading is four times that when the addition reading is performed. Hence, it takes a period approximately equal to the unit period Δt to read, from the image sensor 33, pixel signals of one frame of the low-resolution input image, whereas it takes a period approximately four times the unit period Δt to read, from the image sensor 33, pixel signals of one frame of the high-resolution input image.

Consequently, as shown in FIG. 14, the high-resolution input image H₁ is acquired from the image sensor 33, then low-resolution input images L₂ to L₄ are not acquired from the image sensor 33 and the low-resolution input images L₅ to L₈ are acquired from the image sensor 33 at timings t₅ to t₈, respectively. Thereafter, the high-resolution input image H₉ is acquired from the image sensor 33. The images H₁ and H₉ are the high-resolution input images acquired at timings t₁ and t₉. The same operation as the one in which one high-resolution input image and four low-resolution input images are acquired at timings t₁ to t₈ is repeated at timing t₉ and the subsequent timings.

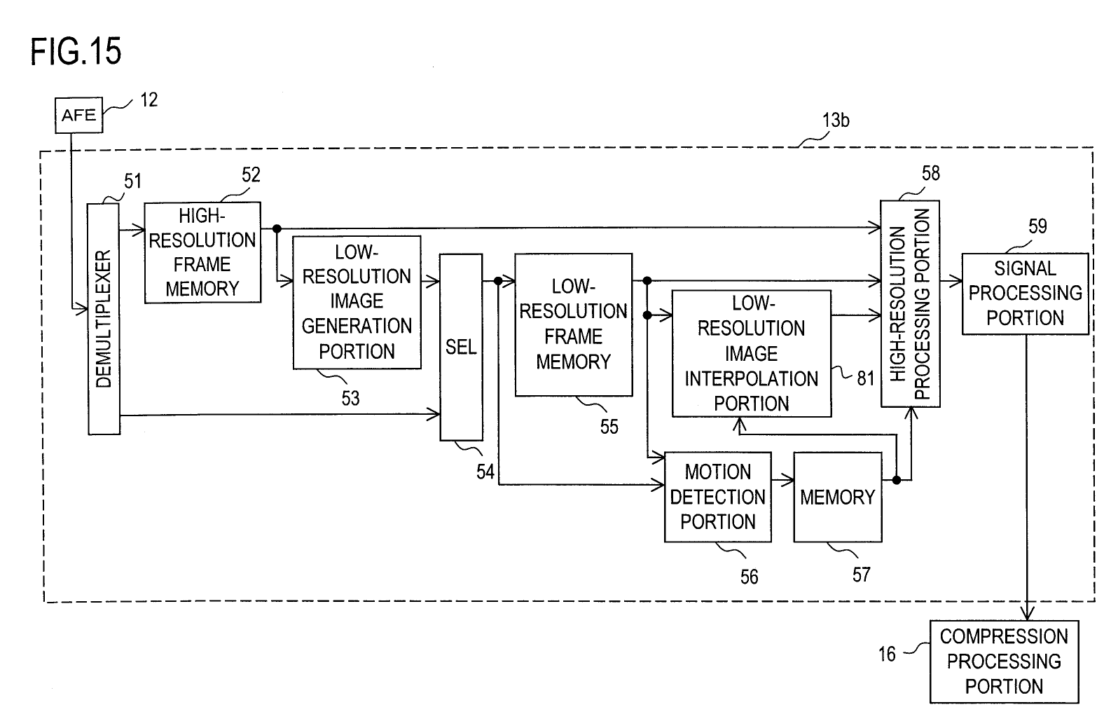

In order for the high-resolution output image sequence shown in FIG. 10 to be generated, the low-resolution image sequences that are spaced periodically and chronologically are required. Thus, the video signal processing portion according to this embodiment is formed as shown in FIG. 15. FIG. 15 is a partial block diagram of the image sensing device 1 including an internal block diagram of the video signal processing portion 13b according to this embodiment. The video signal processing portion 13b functions as the video signal processing portion 13 shown in FIG. 1. The video signal processing portion 13b differs from the video signal processing portion 13a shown in FIG. 8 in that a low-resolution image interpolation portion 81 is added.

Likewise, in this embodiment, the low-resolution image generation portion 53 generates the low-resolution images L₁ and L₉ from the images H₁ and H₉ (see FIG. 9), and the motion detection portion 56 calculates an optical flow (a motion vector) between the sequentially adjacent two low-resolution images. In this example, since the image data on the images L₂ to L₄ is not output directly from the image sensor 33, the motion detection portion 56 calculates, based on the image data on the images L₁ and L₅, a motion vector M_{1, 5} between the images L₁ and L₅. On the other hand, as in the first embodiment, motion vectors M_{5, 6}, M_{6, 7}, M_{7, 8}, M_{8, 9} . . . are also calculated, and the calculated motion vectors are stored in the memory 57.

In order to obtain the low-resolution image sequences that are spaced periodically and chronologically, the low-resolution image interpolation portion 81 estimates, based on the image data on the low-resolution images stored in the low-resolution frame memory 55 and the motion vectors stored in the memory 57, the low-resolution images by interpolation. Here, the low-resolution images to be estimated include the low-resolution images L₂ to L₄ at timings t₂ to t₄.

Specifically, the image L₂ is estimated as follows. The ratio of a period between timing t₁ and timing t₂ corresponding to the image L₂ to a period (4×Δt) between timing t, and timing t₅ is determined. This ratio is 1/4. Then, the magnitude of the motion vector M_{1, 5} is corrected by the ratio, and thus the magnitude of the motion vector M_{1, 2} is estimated. Specifically, the magnitude of the motion vector M_{1, 2} is estimated such that the magnitude of the motion vector M_{1, 2} is one-fourth that of the motion vector M_{1, 5}. On the other hand, the direction of the motion vector M_{1, 2} is estimated to coincide with that of the motion vector M_{1, 5}. Thereafter, the image obtained by displacing the position of objects within the image L₁ according to the motion vector M_{1, 2} is estimated as the image L₂.

Although, for specific description, the method of estimating the low-resolution image is discussed by focusing on the image L₂, the same method is applied to the cases where the images L₃ and L₄ are estimated. For example, when the image L₃ is estimated, since the above-described ratio is 1/2, a vector that is half the magnitude of the motion vector M_{1, 2} and that points in the direction in which the motion vector M_{1, 2} points is estimated as the motion vector M_{1, 3}. Then, the image obtained by displacing the position of objects within the image L₁ according to the motion vector M_{1, 3} is preferably estimated as the image L₃.

After the low-resolution image sequences including the images L₁ to L₉ are obtained in this way, the same operation as in the first embodiment is performed.

### Fourth Embodiment

The fourth embodiment of the present invention will be described. The basic configuration and the operation of an image sensing device according to the fourth embodiment are the same as those of the image sensing device 1 according to the first or third embodiment. However, although, in the first or third embodiment, the switching between the all-pixel reading and the addition reading is performed such that the all-pixel reading is performed periodically, in this embodiment, this switching is performed in consideration of whether or not a specific condition is satisfied. As examples of the switching method, the first to fourth switching methods will be shown below. The control of the switching between the all-pixel reading and the addition reading described in the first or third embodiment is hereinafter referred to as “basic switching control.”

### [First Switching Method]

The first switching method will now be described. In the first switching method, in consideration of an instruction given by the user's operation on the shutter button 26b (see FIG. 1), the switching between the all-pixel reading and the addition reading is controlled. As described previously, the shutter button 26b is a push-button switch with which an instruction is given to shoot a still image.

A two-stage pressing operation can be performed with the shutter button 26b. When the user lightly presses the shutter button 26b, the shutter button 26b is brought into a halfway pressed state, and then, when the shutter button 26b is further pressed from this state, the shutter button 26b is brought into a completely pressed state. Immediately after the CPU 23 finds that the shutter button 26b is in the completely pressed state, the shooting of a still image is performed.

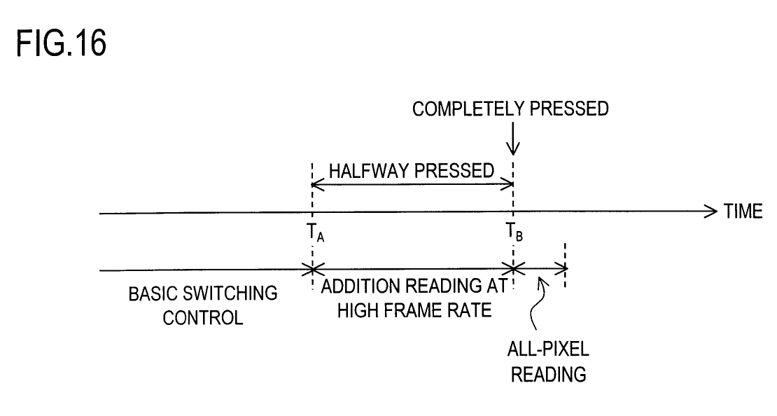

A specific example of achieving the first switching method will be described with reference to FIG. 16. When, in the shooting mode, an instruction is given to shoot and record moving images, the basic switching control is first performed, and a high-resolution output image sequence thus obtained is stored in the external memory 18. When the user presses the shutter button 26b at timing T_{A}, the shutter button 26b is brought into the halfway pressed state, and then this state is kept from timing T_{A} immediately before timing T_{B} is reached and the shutter button 26b is considered to be brought into the completely pressed state at timing T_{B}.

In this case, during which the shutter button 26b is in the halfway pressed state, the all-pixel reading is not performed, and the addition reading in which signals can be read with low power consumption and a high frame rate is only repeated. Then, when the shutter button 26b is found to be brought into the completely pressed state at timing T_{B}, exposure to light for a still image and the all-pixel reading are performed immediately from timing T_{B}. For example, the exposure to light for a still image is started from timing T_{B}, and, after the completion of the exposure to light, light receiving pixel signals accumulated by the exposure to light are read by the all-pixel reading from the image sensor 33, with the result that a high-resolution input image is acquired. Then, the high-resolution input image itself or an image obtained by performing predetermined image processing (such as demosaicing processing) on the high-resolution input image is stored as a still image in the external memory 18. After completion of the all-pixel reading for acquisition of a still image, the basic switching control is performed again. The high-resolution input image acquired for generation of a still image is also used for generation of a high-resolution output image sequence.

In a period during which the shutter button 26b is in the halfway pressed state, autofocus control is performed to focus on the main subject of the image sensing device 1. The autofocus control is achieved by driving and controlling a focus lens (not shown) within the image sensing portion 11, according to, for example, a contrast detection method in a TTL (through the lens) mode and based on signals output from the image sensor 33 during the above-described period. Alternatively, it is possible to achieve the autofocus control based on the result obtained by the measurement of a distance-measuring sensor (not shown) that measures the distance between the main subject and the image sensing device 1.

It is preferable that a still image obtained through the user's instruction be higher in quality than each of frames that constitute moving images. Thus, when a still image is acquired, the all-pixel reading is used. When an instruction is given by the user to shoot a still image, it is required to acquire the image of a subject at a time that is closest to when the instruction is given.

In a case where, in order for an increase in power consumption to be reduced, as in the third embodiment, the drive rate of the image sensor 33 when the all-pixel reading is performed is set approximately equal to that when the addition reading is performed, if the all-pixel reading for generation of moving images is started immediately before timing T_{B}, it is impossible to perform, until the above-mentioned all-pixel reading is completed, the subsequent round of the all-pixel reading (that is, the all-pixel reading for generation of a still image). Consequently, the all-pixel reading for generation of a still image may be started much later than timing T_{B}. With the first switching method, it is possible to avoid such a problem. When the autofocus control is performed based on the contrast detection method, a focus speed (the reciprocal of a period necessary to focus on the main subject) increases with the frame rate. From this standpoint, the first switching method is beneficial.

### [Second Switching Method]

The second switching method will be described. In the second switching method, when the magnitude of a motion vector over an entire image is relatively small, the all-pixel reading is performed.

The second switching method will be more specifically described. In the second switching method, when the shooting of moving images is started, the addition reading is repeatedly performed periodically, and thus a low-resolution input image sequence is acquired, and the motion detection portion 56 shown in FIG. 8 sequentially calculates a motion vector (hereinafter referred to as an entire motion vector) over an entire image between sequentially adjacent two low-resolution input images. The optical flow determined, by the motion detection portion 56, between two images is composed of a bunch of motion vectors in various positions on an image coordinate plane in which any image including a low-resolution image is defined. For example, the entire image regions of two images from which an optical flow is calculated are individually divided into a plurality of partial image regions, and one motion vector (hereinafter referred to as a region motion vector) is determined for each partial image region. The average of a plurality of region motion vectors determined for a plurality of partial image regions is the entire motion vector.

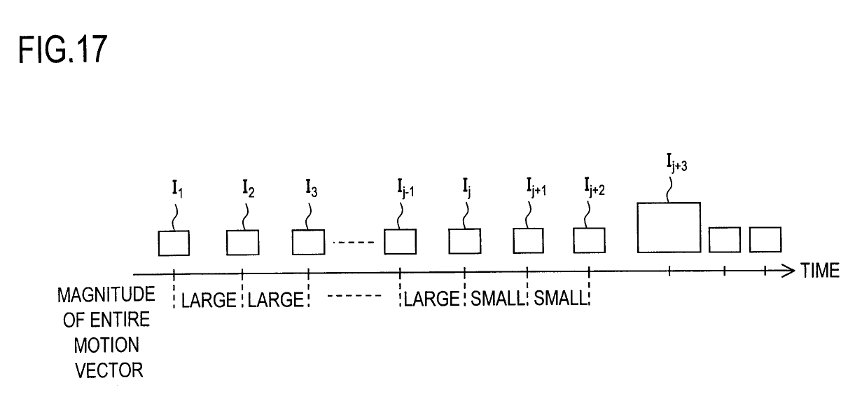

As shown in FIG. 17, low-resolution input images I₁, I₂, I₃, . . . Iⱼ₋₁, Iⱼ, Iⱼ₊₁, Iⱼ₊₂ are considered to be obtained in this order (“j” represents a integer) by the addition reading that is preformed periodically and sequentially. The motion detection portion 56 calculates the entire motion vector for each combination of adjacent two images among the images I₁ to Iⱼ₊₂. The CPU 23 controls the reading method such that, when the calculated entire motion vectors are referenced and the magnitude of the entire motion vectors is kept equal to or smaller than a predetermined standard magnitude for a predetermined period, the all-pixel reading is performed. In other words, after sequential Q entire motion vectors are found to be all equal to or smaller than the predetermined standard magnitude, the all-pixel reading is performed. In the example shown in FIG. 17, Q=2. Q may be an integer equal to or more than 3 or may be 1.

The conditions shown in FIG. 17 will be described. In the example shown in FIG. 17, the magnitude of the entire motion vector of any adjacent two images among the images I₁ to Iⱼ is larger than the standard magnitude. Thus, the all-pixel reading is not performed during which the images I₁ to Iⱼ are acquired and immediately after the image Iⱼ is acquired. On the other hand, both the magnitude of the entire motion vector between the images Iⱼ and Iⱼ₊₁ and the magnitude of the entire motion vector between the images Iⱼ₊₁ and Iⱼ₊₂ are smaller than the standard magnitude. Since Q=2, the all-pixel reading is not performed on the image succeeding the image Iⱼ₊₁ but the all-pixel reading is performed on the image succeeding the image Iⱼ₊₂, and, in this round of the all-pixel reading, the high-resolution input image Iⱼ₊₃ is acquired. After the high-resolution input image Iⱼ₊₃ is acquired, the addition reading is performed again, and the same operation as the one in which the images I₁ to Iⱼ₊₃ are acquired is repeatedly performed.

If the method described in the third embodiment is not utilized, since the all-pixel reading causes the power consumption to be increased, the unnecessary all-pixel reading is preferably avoided. During which the magnitude of the entire motion vector is relatively large, since the variation of the position of the subject within the image to be acquired is considered to be large, even if the all-pixel reading in which a high definition image can be provided is performed during such a period, the all-pixel reading improves only a low degree of image quality. In consideration of these conditions, when the magnitude of the entire motion vector is found to be relatively small, the all-pixel reading is performed. In this way, the all-pixel reading is effectively performed, and an unnecessary increase in power consumption is avoided.

Although, in the example described above, during which the magnitude of the entire motion vector remains larger than the standard magnitude, the addition reading alone is repeatedly performed, the basic switching control may be performed during such a period. In order for an increase in power consumption to be reduced, the frequency at which the all-pixel reading is performed may be limited. Specifically, once the all-pixel reading is performed, irrespective of the magnitude of the entire motion vector, the all-pixel reading may be limited such that the subsequent round of the all-pixel reading is not performed again for a given period.

### [Third Switching Method]

The third switching method will be described. In the third switching method, when the magnitude of the motion of an object on an image is relatively large or a plurality of motions are present on the image, the frequency at which the addition reading is performed is increased as compared with when this is not the case.

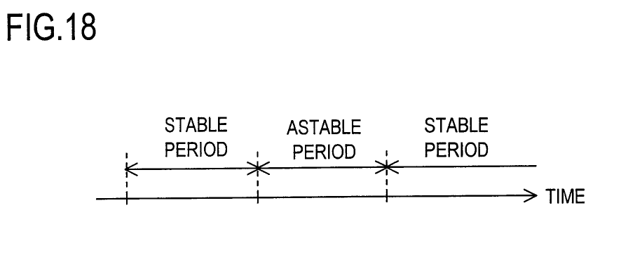

The third switching method will be more specifically described. When the third switching method is applied, the entire period during which moving images are shot is divided into a plurality of periods, as shown in FIG. 18. The plurality of periods include stable periods and astable periods. The stable period and the astable period differ in the ratio L_{NUM}/H_{NUM} of the number L_{NUM} of low-resolution input images acquired to the number H_{NUM} of high-resolution input images acquired; the ratio L_{NUM}/H_{NUM} in the astable period is set larger than that in the stable period. For example, in the stable period, the ratio L_{NUM}/H_{NUM} is set such that L_{NUM}/H_{NUM}=7/1, whereas, in the astable period, the ratio L_{NUM}/H_{NUM} is set such that L_{NUM}/H_{NUM}=15/1.

Based on the result obtained by detection of the motion by the motion detection portion 56, the CPU 23 divides the entire period into the stable periods and the astable periods and determines the ratio L_{NUM}/H_{NUM}. This dividing method will be described.

As described in the discussion of the second switching method, the entire image regions of sequentially adjacent two low-resolution images are individually divided into a plurality of partial image regions, and a plurality of region motion vectors and one entire motion vector are calculated for the two low-resolution images. When the magnitude of the entire motion vector of the two low-resolution images of interest is larger than a predetermined standard magnitude or the magnitude of any region motion vector of the two low-resolution images of interest is larger than the predetermined standard magnitude, the CPU 23 determines that the motion of an object (motion on an image) between the two low-resolution images of interest is relatively large; when this is not the case, the CPU 23 determines that the motion of the object (motion on the image) between the two low-resolution images of interest is relatively small.

The motion detection portion 56 has the function of determining, for each partial image region, whether or not a plurality of motions are present within a partial image region between the two low-resolution images of interest. As a method for determining whether or not a plurality of motions are present, any method including a known method (for example, a method disclosed in JP-A-2008-060892) can be employed. When a plurality of motions are determined to be present in any partial image region of the two low-resolution images of interest, the CPU 23 determines that a plurality of motions (motions on the image) are present between the two low-resolution images of interest; when this is not the case, a plurality of motions (motions on the image) are determined not to be present between the two low-resolution images of interest.

Then, the CPU 23 divides the entire period into the stable periods and the astable periods such that the two low-resolution images in which the motion of the object is determined to be relatively large and/or the two low-resolution images in which a plurality of motions are determined to be present fall within the astable period and that the two low-resolution images in which the motion of the object is determined to be relatively small and/or the two low-resolution images in which a plurality of motions are determined not to be present fall within the stable period.

If the method described in the third embodiment is not utilized, since the all-pixel reading causes the power consumption to be increased, the unnecessary all-pixel reading is preferably avoided. Since, during the astable period, the variation of the position of the subject within the image to be acquired is considered to be large or the accuracy with which the motion vector is detected is considered to be low, even if the all-pixel reading in which a high definition image can be provided is performed during the astable period, only a low degree of image quality is improved. In consideration of these conditions, during the astable period, the ratio L_{NUM}/H_{NUM} is relatively increased. In this way, the frequency at which the all-pixel reading where only a low degree of image quality is improved is performed is reduced, and an unnecessary increase in power consumption is avoided.

### [Fourth Switching Method]

The fourth switching method will be described. In the fourth switching method, the ratio L_{NUM}/H_{NUM} is varied according to the remaining capacity of the drive source of the image sensing device 1.

The fourth switching method will be more specifically described. The image sensing device 1 is so formed as to operate on a battery (not shown) such as a secondary battery serving as the drive source. A remaining capacity detection portion (not shown) for detecting the remaining capacity of this battery is provided in the image sensing device 1, and, as the remaining capacity detected is decreased, the ratio L_{NUM}/H_{NUM} is increased continuously or stepwise. For example, when the remaining capacity detected is compared with a predetermined standard remaining capacity and the remaining capacity detected is larger than the standard remaining capacity, the ratio is set such that L_{NUM}/H_{NUM}=7/1, whereas, when the remaining capacity detected is smaller than the standard remaining capacity, the ratio is set such that L_{NUM}/H_{NUM}=15/1.

In this way, when the remaining capacity is relatively large, the ratio L_{NUM}/H_{NUM} is set at a relatively low ratio, with the result that a high-resolution output image sequence of relatively high quality is generated. On the other hand, when the remaining capacity is relatively small, the ratio L_{NUM}/H_{NUM} is set at a relatively high ratio. As the ratio L_{NUM}/H_{NUM} is increased, the quality of the high-resolution output image sequence is relatively lowered; on the other hand, since the power consumption is reduced, the battery lasts longer. When the remaining capacity of the battery is small, it is probably advantageous for the user to give high priority to the reduction of the power consumption as compared with the improvement of image quality.

### Fifth Embodiment

The fifth embodiment of the present invention will be described. Although, in the first to fourth embodiments, the high-resolution output image sequence is considered to be generated in real time when an image is shot with the image sensor 33, the high-resolution output image sequence may be generated, for example, when the image is reproduced

For example, with the method of any of the above-described embodiments, a high-resolution input image sequence and a low-resolution input image sequence are obtained from the image sensor 33. Then, predetermined signal processing and compression processing are individually performed on the image data on the high-resolution input image sequence and the low-resolution input image sequence, and the compressed image data thus obtained is stored in the external memory 18 (it is alternatively possible to omit the signal processing and/or the compression processing). Here, high-resolution input images that constitute the high-resolution input image sequence and low-resolution input images that constitute the low-resolution input image sequence are stored in the external memory 18 such that they correspond in time to each other.

Specifically, for example, when the high-resolution input image sequence including images H₁ and H₉ and the low-resolution input image sequence including the images L₂ to L₈, which are shown in FIG. 7, are recorded in the external memory 18, the image data is recorded such that the images H₁, L₂, L₃, L₄, L₅, L₆, L₇, L₈ and H₉ are found to be obtained at timings t₁, t₂, t₃, t₄, t₅, t₆, t₇, t₈ and t₉. A record control portion control portion) for controlling such recording can be considered to be included in the video signal processing portion 13 (or the CPU 23).

After completion of such recording, as necessary, the image sequence composed of the high-resolution input image sequence and the low-resolution input image sequence stored in the external memory 18 is preferably fed in sequential order to the video signal processing portion 13a or 13b shown in FIG. 8 or FIG. 15. Thus, the image data on the high-resolution output image sequence described above is output from the high-resolution processing portion 58. It is possible to record the high-resolution output image sequence in the external memory 18 through the signal processing portion 59 and the compression processing portion 16 or to reproduce and display it as moving images on the display portion 27 shown in FIG. 1 or on the external display device (not shown) for the image sensing device 1.

The compression processing performed on the high-resolution input image sequence and the compression processing performed on the low-resolution input image sequence may be used as compression processing (for example, compression processing corresponding to the MPEG compression method) for moving images; the compression processing on a high-resolution input image sequence with a relatively low frame rate may be used as compression processing (for example, compression processing corresponding to the JPEG (joint photographic experts group) compression method) for still images. Audio signals that are obtained when moving images composed of the high-resolution input image sequence and the low-resolution input image sequence are shot are stored such that, when the image data is recorded in the external memory 18, they correspond to the image data. Here, the recording is controlled such that the audio signals can be reproduced in synchronization with the high-resolution output image sequence.

A reproduction device 400 that is an external unit for the image sensing device 1 may have the function of generating the high-resolution output image sequence from the high-resolution input image sequence and the low-resolution input image sequence. In this case, portions (such as the low-resolution image generation portion 53 and the high-resolution processing portion 58) of the image sensing device 1 that perform the above-described function can be omitted, and this allows the power consumption of the image sensing device 1 to be reduced. The size of image data recorded when shooting is performed can be reduced as compared with the embodiments such as the first embodiment.

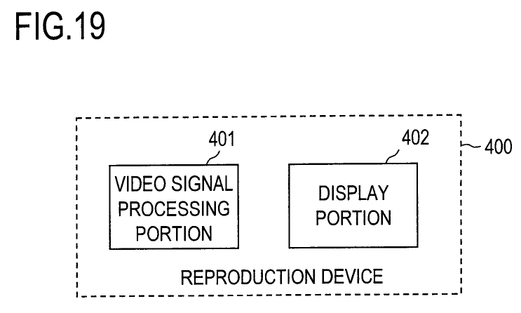

The schematic block diagram of the reproduction device 400 is shown in FIG. 19. The reproduction device 400 is provided with a video signal processing portion 401 (image processing device) that has the same configuration as that of the video signal processing portion 13a or 13b shown in FIG. 8 or FIG. 15 and a display portion 402 such as a liquid crystal display. The image sequence composed of the high-resolution input image sequence and the low-resolution input image sequence stored in the external memory 18 is fed in sequential order to the video signal processing portion 401, with the result that the above-described processing for generating the high-resolution output image sequence is performed and the image data on the high-resolution output image sequence is output from the high-resolution processing portion 58 within the video signal processing portion 401. This high-resolution output image sequence can be reproduced and displayed as moving images on the display portion 402.

### Sixth Embodiment

The sixth embodiment of the present invention will be described. In the sixth embodiment, with the method of any of the above-described embodiments, the high-resolution input image sequence and the low-resolution input image sequence are acquired from the image sensor 33, and the low-resolution image is generated from the image data on the high-resolution input image by use of the low-resolution image generation portion 53 within the image sensing device 1. Here, the low-resolution image sequence composed of the low-resolution input image sequence and the low-resolution image generated by the low-resolution image generation portion 53 is generated. Then, without the high-resolution output image sequence being generated, predetermined signal processing and compression processing are individually performed on the image data on the low-resolution image sequence and the high-resolution input image sequence, and the compressed image data thus obtained is recorded in the external memory 18 (it is alternatively possible to omit the signal processing and/or the compression processing). In this case, the high-resolution input images that constitute the high-resolution input image sequence and low-resolution images that constitute the low-resolution image sequence are stored in the external memory 18 such that they correspond in time to each other.

Specifically, for example, when the high-resolution input image sequence including the images H₁ and H₉ and the low-resolution input image sequence including the images L₂ to L₈, which are shown in FIG. 7, are obtained as a result of the image sensor 33 performing the shooting, the low-resolution images L₁ and L₉ are generated from the images H₁ and H₉, and then the image data on the high-resolution input image sequence including the images H₁ and H₉ and the low-resolution image sequence including the images L₁ to L₉ are stored in the external memory 18. In this case, the image data is recorded such that the images H₁ and H₉ are found to be obtained at timings t₁ and t₉, respectively, and that the images L₁, L₂, L₃, L₄, L₅, L₆, L₇, L₈ and L₉ are found to be obtained at timings t₁, t₂, t₃, t₄, t₅, t₆, t₇, t₈ and t₉, respectively. The record control portion (or storage control portion) for controlling such recording can be considered to be included in the video signal processing portion 13 (or the CPU 23).

By performing such record control, it is possible not only to decrease the amount of image data processed when shooting is performed and thus reduce the power consumption of the image sensing device 1 as compared with the embodiments such as the first embodiment but also to reduce the size of image data recorded when shooting is performed as compared with the embodiments such as the first embodiment.

By feeding the image data (compressed image data) recorded in the external memory 18 to the reproduction device that is an external device for the image sensing device 1, it is possible to reproduce and display, on the reproduction device, as moving images, the high-resolution input image sequence including the images H₁ and H₉, the low-resolution image sequence including the images L₁ to L₉ or the high-resolution output image sequence including the images H₁′ and H₉′. The image sensing device 1 may have the function of the video signal processing portion 13a or 13b; in this case, it is possible to generate and display, on the image sensing device 1, the high-resolution output image sequence from the contents of the external memory 18.

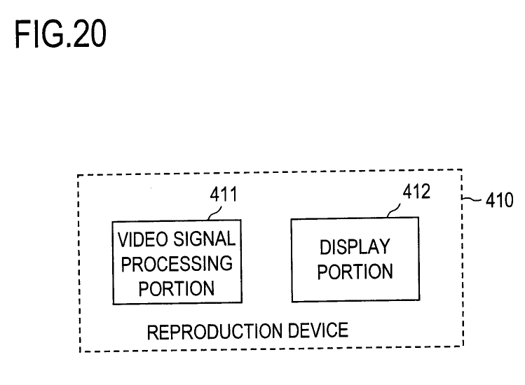

The schematic block diagram of a reproduction device 410 according to the sixth embodiment is shown in FIG. 20. The reproduction device 410 is provided with a video signal processing portion (image processing device) 411 and a display portion 412 such as a liquid crystal display. A high-resolution processing block can be provided within the video signal processing portion 411. This high-resolution processing block has the function of generating the high-resolution output image sequence including the images H₁′ and H₉′ based on the high-resolution input image sequence including the images H₁ and H₉ recorded in the external memory 18 and the low-resolution image sequence including the images L₁ to L₉. Among the portions that constitute the video signal processing portion 13a or 13b shown in FIG. 8 or FIG. 15, portions (including at least the high-resolution processing portion 58) that have the above-described function are provided in the high-resolution processing block.

When the video signal processing portion 411 is provided with the high-resolution processing block, the reproduction device 410 switchably controls, according to the resolution of the display screen of the display portion 412, whether or not the high-resolution output image sequence is generated. Specifically, when the display screen of the display portion 412 has a resolution equal to or higher than a predetermined resolution corresponding to the resolution of the high-resolution output image, the high-resolution processing block is used to generate the high-resolution output image sequence from the image data recorded in the external memory 18, and the high-resolution output image sequence is reproduced and displayed, as moving images, on the display portion 412. On the other hand, when the display screen of the display portion 412 has a lower resolution than the predetermined resolution, without the use of the high-resolution processing block, the low-resolution image sequence including the images L₁ to L₉ recorded in the external memory 18 is reproduced and displayed, as moving images, on the display portion 412 without being processed.

When the video signal processing portion 411 is not provided with the high-resolution processing block, the low-resolution image sequence including the images L₁ to L₉ recorded in the external memory 18 is reproduced and displayed, as moving images, on the display portion 412 without being processed. By individually recording the high-resolution input image sequence and the low-resolution image sequence in the external memory 18 on the side of the image sensing device 1, it is possible to reproduce moving images that are shot even in the reproduction device that is not provided with the high-resolution processing block. That is, compatibility with the reproduction device that is not provided with the high-resolution processing block is maintained.

Compression processing (for example, compression processing corresponding to the MPEG compression method) for moving images may be used both as the compression processing performed on the high-resolution input image sequence and the compression processing performed on the low-resolution image sequence; compression processing (for example, compression processing corresponding to the JPEG compression method) for still images may be used as the compression processing on the high-resolution input image sequence with a relatively low frame rate. Audio signals that are obtained when moving images composed of the high-resolution input image sequence and the low-resolution input image sequence are shot are also stored such that, when the image data is recorded in the external memory 18, they correspond to the image data. Here, the recording is controlled such that the audio signals can be reproduced in synchronization with the high-resolution input image sequence, the low-resolution image sequence or the high-resolution output image sequence.

### <<Modifications and Others>>

The specific values described in the above discussion are simply given by way of example; naturally, they can be changed to various different values. Alternatively, it is possible to practice the invention by combining what is described in any of the above embodiments with what is described in any other embodiment than the above-mentioned embodiment. Explanatory notes 1 to 3 will be given below as modified examples of the above-described embodiments or explanatory notes. The subject matters of the explanatory notes can be combined together unless they contradict each other.

### [Explanatory Note 1]

Although the above description discusses the example in which the low-resolution input image is acquired by the addition reading shown in FIG. 5, the specific method of adding signals when the addition reading is performed can be freely modified. For example, although, in the example shown in FIG. 5, pixel signals at four pixel positions [1, 1] to [2, 2] on the original image are generated from 4×4 light receiving pixels composed of light receiving pixels Pₛ [1, 1] to Pₛ [4, 4], the pixel signals at four pixel positions [1, 1] to [2, 2] on the original image may be generated from other 4×4 light receiving pixels (for example, 4×4 light receiving pixels composed of light receiving pixels Pₛ [2, 2] to Pₛ [5, 5]). Although, in the example shown in FIG. 5, one pixel signal on the original image is formed by adding four light receiving pixel signals, one pixel signal on the original image may be formed by adding a number of light receiving pixel signals other than four (for example, nine light receiving pixel signals).

When the low-resolution input image is acquired by the skipping reading, the skipping reading method can be freely modified. For example, although, in the example shown in FIG. 6, pixel signals at four pixel positions [1, 1] to [2, 2] on the original image are generated from light receiving pixels Pₛ [2, 2] to Pₛ [3, 3], the pixel signals at four pixel positions [1, 1] to [2, 2] on the original image may be generated from light receiving pixels Pₛ [1, 1] to Pₛ [2, 2]. Although, in the example shown in FIG. 6, the small light receiving pixel regions are formed in units of 4×4 light receiving pixels, the unit of the small light receiving pixel region may be changed. For example, the small light receiving pixel regions are formed in units of 9×9 light receiving pixels, and four light receiving pixel signals are selected by the skipping reading from the total of 81 light receiving pixel signals on the 9×9 light receiving pixels, with the result that the four light receiving pixel signals selected may be used as pixel signals at four pixel positions [1, 1] to [2, 2] on the original image.

Moreover, the low-resolution input image may be acquired by use of a reading method (hereinafter referred to as an addition/skipping method) in which the addition reading method and the skipping reading method are combined together. In the addition/skipping method, as in the addition reading method, pixel signals for the original image are formed by adding together a plurality of light receiving pixel signals. Hence, the addition/skipping method is one type of the addition reading method. On the other hand, among light receiving pixel signals within the effective region of the image sensor 33, some of the light receiving pixel signals are not involved in the generation of the pixel signals for the original image. In other words, when the original image is generated, some of the light receiving pixel signals are skipped. Hence, the addition/skipping method can be considered as one type of the skipping reading method.

### [Explanatory Note 2]

Although, in the above-described examples, the single-panel method in which only one image sensor is used is considered to be employed in the image sensing device 1, the three-panel method in which three image sensors are used may be employed in the image sensing device 1.

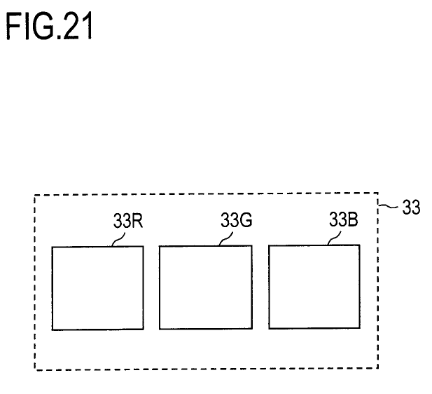

When the image sensor 33 is an image sensor employing the three-panel method, as shown in FIG. 21, the image sensor 33 is composed of three image sensors 33R, 33G and 33B. The image sensors 33R, 33G and 33B are individually formed with a CCD, a CMOS image sensor or the like; they photoelectrically convert an optical image incident through an optical system, and outputs an electrical signal obtained by the photoelectric conversion to the AFE 12. The image sensors 33R, 33G and 33B are individually provided with (M×N) light receiving pixels that are two-dimensionally arranged in a matrix. The (M×N) light receiving pixels are light receiving pixels within the effective region. Through the optical system of the image sensing portion 11, the image sensors 33R, 33G and 33B respond to only the red, green and blue components, respectively, of light incident through the optical system of the image sensing portion 11.

As pixel signals are read from the image sensor 33 employing the single-panel method, pixel signals are individually read from the image sensors 33R, 33G and 33B by the all-pixel reading method, the addition reading method or the skipping reading method, with the result that the original image is acquired. When the three-panel method is employed, unlike the single-panel method, R, G and B signals are all present at one pixel position on the original image. Other than this point, the configuration and the operation of the image sensing device, the reproduction device and the like employing the three-panel method are the same as those described above. Even in the three-panel method, when the all-pixel reading is performed, the original image having the (M×N) image size is acquired as the high-resolution input image, whereas, when the addition reading or the skipping reading is performed, the original image having the (M/2×N/2) image size is acquired as the low-resolution input image. Alternatively, it is possible to set the size of the low-resolution input image acquired by the addition reading or the skipping reading at a size other than the (M/2×N/2) image size.

### [Explanatory Note 3]

The image sensing device 1 shown in FIG. 1, the reproduction device 400 shown in FIG. 19 and the reproduction device 410 shown in FIG. 20 each can be provided either by hardware or by combination of hardware and software. In particular, part of the processing performed within the video signal processing portion (13, 13a, 13b, 401 or 411) can be performed by software. Naturally, the video signal processing portion (13, 13a, 13b, 401 or 411) can be formed by hardware alone. When the image sensing device or the reproduction device is formed by use of software, a block diagram for portions that are provided by software represents a functional block diagram for those portions.

What is claimed is:

1. An image sensing device comprising:
an image acquisition portion that switches between a plurality of reading methods in which pixel signals of a group of light receiving pixels arranged in an image sensor are read and that thereby acquires, from the image sensor, a first image sequence formed such that a plurality of first images having a first resolution are arranged chronologically and a second image sequence formed such that a plurality of second images having a second resolution higher than the first resolution are arranged chronologically; and
an output image sequence generation portion that generates, based on the first and second image sequences, an output image sequence formed such that a plurality of output images having the second resolution are arranged chronologically,
wherein a time interval between sequentially adjacent two output images among the plurality of output images is shorter than a time interval between sequentially adjacent two second images among the plurality of second images.

2. The image sensing device of claim 1, further comprising:
an image compression portion that performs image compression on the output image sequence to generate compressed moving images including an intra-coded picture and a predictive-coded picture, the output image sequence composed of a first output image that is generated, according to a timing at which a first image among the first images is acquired, from the first image and a second image among the second images and a second output image that is generated, according to a timing at which the second image is acquired, from the second image,
wherein the image compression portion preferentially selects, as a target of the intra-coded picture, the second output image from the first and second output images and generates the compressed moving images.

3. The image sensing device of claim 1,
wherein the image acquisition portion periodically and repeatedly performs an operation in which reading of the pixel signals for acquiring a first image among the first images from the image sensor and reading of the pixel signals for acquiring a second image among the second images from the image sensor are performed in a specified order, and thereby acquires the first and second image sequences.

4. The image sensing device of claim 1, further comprising:
a shutter button through which an instruction is received to acquire a still image having the second resolution,
wherein, based on the instruction received through the shutter button, the image acquisition portion switches between reading of the pixel signals for acquiring a first image among the first images from the image sensor and reading of the pixel signals for acquiring a second image among the second images from the image sensor, and performs the reading.

5. The image sensing device of claim 1, further comprising:
a motion detection portion that detects a motion of an object on an image between different second images among the plurality of second images,
wherein, based on the detected motion, the image acquisition portion switches between reading of the pixel signals for acquiring a first image among the first images from the image sensor and reading of the pixel signals for acquiring a second image among the second images from the image sensor, and performs the reading.

6. The image sensing device of claim 1,
wherein one or more first images are acquired during which sequentially adjacent two second images are acquired; the output image sequence generation portion includes a resolution conversion portion that generates third images by reducing a resolution of the second images to the first resolution; when a frame rate of the output image sequence is called a first frame rate and a frame rate of the second image sequence is called a second frame rate, the first frame rate is higher than the second frame rate; and the output image sequence generation portion generates, from the second image sequence, a third image sequence of the second frame rate by use of the resolution conversion portion, and thereafter generates the output image sequence of the first frame rate based on the second image sequence of the second frame rate and an image sequence of the first frame rate formed with the first and third image sequences.

7. The image sensing device of claim 1,
wherein the image acquisition portion reads the pixel signals from the image sensor such that a first image among the first images and a second image among the second images have a same field of view.

8. An image sensing device comprising:
an image acquisition portion that switches between a plurality of reading methods in which pixel signals of a group of light receiving pixels arranged in an image sensor are read and that thereby acquires, from the image sensor, a first image sequence formed such that a plurality of first images having a first resolution are arranged chronologically and a second image sequence formed such that a plurality of second images having a second resolution higher than the first resolution are arranged chronologically; and
a storage control portion that stores the first and second image sequences in a record medium such that the first images correspond to the second images.

9. An image processing device comprising:
an output image sequence generation portion that generates, based on stored contents of the record medium of claim 8, an output image sequence formed such that a plurality of output images having the second resolution of claim 8 are arranged chronologically,
wherein a time interval between sequentially adjacent two output images among the plurality of output images is shorter than a time interval between sequentially adjacent two second images among the plurality of second images of claim 8.

10. The image sensing device of claim 8,
wherein the image acquisition portion reads the pixel signals from the image sensor such that a first image among the first images and a second image among the second images have a same field of view.
